(19) United States
(12) Patent Application Publication
(10) Pub. No.: US 2024/0172025 A1
(43) Pub. Date: May 23, 2024

(54) CHANNEL STATE INFORMATION FEEDBACK METHOD AND COMMUNICATION APPARATUS

(71) Applicant: HUAWEI TECHNOLOGIES CO., LTD., Shenzhen (CN)

(72) Inventors: Shengyu LI, Beijing (CN); Lei GUAN, Beijing (CN)

(21) Appl. No.: 18/426,785

(22) Filed: Jan. 30, 2024

Related U.S. Application Data
(63) Continuation of application No. PCT/CN2022/103861, filed on Jul. 5, 2022.

(30) Foreign Application Priority Data
Jul. 31, 2021 (CN) 202110877183.5

(51) Int. Cl. H04W 24/10; H04L 5/00

(52) U.S. Cl. CPC H04W 24/10; H04L 5/0057

(57) ABSTRACT

A channel state information feedback method and a communication apparatus. A network device sends reference signal configuration information to a terminal device, where the reference signal configuration information is usable for configuring N_1 reference signals, and the N_1 reference signals correspond to N antenna ports. The terminal device determines K_1 first channel vectors based on K_1 combination matrices and measurement results of the N_1 reference signals on the N antenna ports, where an ith combination matrix in the K_1 combination matrices is usable for combining the N antenna ports into M_i antenna ports; the terminal device further obtains K_1 pieces of channel state information CSI based on the K_1 first channel vectors. Then, the terminal device sends K_2 pieces of CSI in the K_1 pieces of CSI to the network device.

### CROSS-REFERENCE TO RELATED APPLICATION

This application is a continuation of International Application No. PCT/CN2022/103861, filed on Jul. 5, 2022, which claims priority to Chinese Patent Application No. 202110877183.5, filed on Jul. 31, 2021. The disclosures of the aforementioned applications are hereby incorporated by reference in their entireties.

### BACKGROUND

A multiple-input multiple-output (MIMO) technology is outstanding because the technology uses limited spectrum resources to greatly improve transmission reliability and increase a transmission capacity. In a low frequency, the MIMO technology is mainly implemented in digital domain, and includes digital domain precoding and digital domain beamforming. To be specific, one antenna element corresponds to one digital channel. The digital channel includes a whole set of processing components including a digital-to-analog converter/analog-to-digital converter (DAC/ADC), a filter, and a power amplifier (PA). However, in a high frequency, especially in a millimeter wave (mmWave), a frequency of a radio frequency signal is excessively high, and a quantity of antenna elements that is deployed on a base station side is excessively large, for example, 1024 or 2048. In addition, an extremely high frequency of the radio frequency signal and an extremely large available bandwidth cause increasingly high costs of the components such as the DAC/ADC, the filter, and the PA. Deploying digital channels for all antenna elements in one-to-one correspondence is costly, and a large quantity of processing components further causes an excessively large size of the base station. Therefore, in the high frequency, mainstream base station products all use a hybrid beamforming architecture. To be specific, one digital channel corresponds to a plurality of analog channels, and each analog channel corresponds to one or more antenna elements. In this way, a quantity of digital channels is reduced, to reduce deployment costs and reduce the size of the base station.

In response to cell load being light, the base station shuts down some transmit and receive channels (for example, digital channels or analog channels) to reduce power consumption of components on these channels. Correspondingly, the base station uses more time-frequency resources to ensure that an average transmission rate does not decrease, to ensure data transmission performance. The transmit and receive channel is associated with some antenna elements, and the transmit and receive channel is represented as an antenna port in a protocol. Therefore, channel shutdown is also referred to as “antenna port shutdown” or “antenna shutdown” for short. Currently, channel shutdown used in the product is semi-static. To be specific, a channel shutdown pattern is selected based on a traffic volume prediction within a time period, and service transmission is performed based on the channel shutdown pattern. However, semi-static channel shutdown only matches an average traffic volume within a time period. In each transmission time interval (TTI), service arrival fluctuates. As a result, a traffic volume in some TTIs is large. In this case, shutdown of an excessively large quantity of channels limits a transmission rate. A traffic volume in other TTIs is small. In this case, an energy saving gain cannot be maximized due to shutdown of an excessively small quantity of channels. Therefore, an on-demand and dynamic channel shutdown solution is proposed for each TTI.

Dynamic channel shutdown is also called on-demand channel shutdown. A core idea of dynamic channel shutdown is that in each TTI, the base station maximizes, on a premise of ensuring a service transmission usage, a channel shutdown proportion based on a traffic volume to be transmitted in the TTI, to obtain a maximum instantaneous energy saving gain without affecting user experience. However, because traffic volumes in different TTIs are different, expected channel shutdown patterns are also different. Therefore, the base station cannot send a downlink pilot signal (namely, a downlink reference signal) in advance based on the channel shutdown pattern to enable UE to measure and feed back channel state information (CSI) in the channel shutdown pattern. Accurate link adaptive adjustment cannot be implemented.

In a solution, a base station predefines several antenna channel patterns, and then sends a downlink pilot signal in each channel shutdown pattern in advance, and a terminal device measures and reports CSI respectively corresponding to a plurality of downlink pilot signals. For example, the base station separately sends the downlink pilot signals in a slot 0) based on five channel shutdown patterns, and the terminal device measures and reports the CSI respectively corresponding to the plurality of downlink pilot signals in the slot 0. Subsequently, a network device selects, from CSI corresponding to the five channel shutdown patterns in a slot 1 to a slot 10, CSI corresponding to a corresponding channel shutdown pattern for data transmission. This causes a problem that overheads of the downlink pilot signals increase linearly.

### SUMMARY

Embodiments described herein provide a channel state information feedback method and a communication apparatus, to determine more pieces of CSI in a channel shutdown pattern based on limited downlink pilot signal overheads.

According to a first aspect, at least one embodiment provides a channel state information feedback method. An example in which a terminal device performs the method is used. The method includes: The terminal device receives reference signal configuration information from a network device, where the reference signal configuration information is used for configuring N₁ reference signals, N₁ is a positive integer, the N₁ reference signals correspond to N antenna ports, and N is an integer greater than 1; obtains K₁ first channel vectors based on K₁ combination matrices and measurement results of the N₁ reference signals on the N antenna ports, where an ith combination matrix in the K₁ combination matrices is used for combining the N antenna ports into Mᵢ antenna ports, an i^{th} first channel vector in the K₁ first channel vectors is a channel vector on the Mᵢ antenna ports, Mᵢ is less than or equal to N, Mᵢ is a positive integer, K₁ is a positive integer, and 1≤i≤K₁; obtains K₁ pieces of channel state information CSI based on the K₁ first channel vectors; and sends K₂ pieces of CSI in the K₁ pieces of CSI to the network device, where K₂ is a positive integer less than or equal to K₁.

In the method described in the first aspect, in an HBF architecture, the N antenna ports corresponds to N analog channel subarrays. One digital channel corresponds to a plurality of analog channel subarrays, and one digital channel corresponds to one antenna port. One combination matrix is used for combining the N analog channel subarrays into a plurality of digital channels. Therefore, one combination matrix is in one-to-one correspondence with one analog channel shutdown pattern. CSI corresponding to a plurality of digital channels in an analog channel shutdown pattern is obtained based on a combination matrix corresponding to the analog channel shutdown pattern and measurement results on all of the analog channel subarrays. According to the method described in the first aspect, the network device does not send a downlink reference signal in each analog channel shutdown pattern, but sends only one common downlink reference signal, and the terminal device obtains more pieces of CSI in the analog channel shutdown pattern based on limited pilot overheads. In a full aperture architecture, the N antenna ports corresponds to N digital channels. After some digital channels are closed, corresponding antenna elements is switched to remaining digital channels, so that a quantity of available antenna elements is reserved to maintain a maximum antenna array gain. One combination matrix is used for combining the N digital channels. To be specific, the some digital channels are shut down and the corresponding antenna elements are switched to the remaining digital channels. Therefore, one combination matrix is in one-to-one correspondence with one digital channel shutdown pattern. CSI in a digital channel shutdown pattern is obtained based on a combination matrix corresponding to the digital channel shutdown pattern and measurement results on all of the digital channels. According to the method described in the first aspect, the network device does not send a downlink reference signal in each digital channel shutdown pattern, but sends only one common downlink reference signal, and the terminal device obtains more pieces of CSI in the digital channel shutdown pattern based on limited pilot overheads.

According to a second aspect, at least one embodiment provides a channel state information feedback method. An example in which a network device performs the method is used. The method includes: The network device sends reference signal configuration information to a terminal device, where the reference signal configuration information is used for configuring N₁ reference signals, N₁ is a positive integer, the N₁ reference signals correspond to N antenna ports, and N is an integer greater than 1; sends the N₁ reference signals on the N antenna ports; and receives K₂ pieces of channel state information CSI in K₁ pieces of CSI from the terminal device, where K₂ is a positive integer less than or equal to K₁, the K₁ pieces of CSI are obtained based on K₁ first channel vectors, the K₁ first channel vectors are obtained based on K₁ combination matrices and measurement results of the N₁ reference signals on the N antenna ports, an i^{th} combination matrix in the K₁ combination matrices is used for combining the N antenna ports into Mᵢ antenna ports, an i^{th} first channel vector in the K₁ first channel vectors is a channel vector on the Mᵢ antenna ports, Mᵢ is less than or equal to N, Mᵢ is a positive integer, K₁ is a positive integer, and 1≤i≤K₁.

In at least one embodiment of the first aspect and the second aspect, the Mᵢ antenna ports correspond to Mᵢ digital channels, the N antenna ports correspond to N analog channel subarrays, and Mᵢ is less than N.

In at least one embodiment of the first aspect and the second aspect, the Mᵢ antenna ports correspond to Mᵢ remaining activated digital channels in one digital channel shutdown pattern, the N antenna ports correspond to all of the N digital channels, and Mᵢ is less than N.

In at least one embodiment of the first aspect and the second aspect, the K₁ pieces of CSI include CSI #j, the CSI #j includes a precoding matrix indicator PMI, and the PMI is used for determining a precoding matrix, recommended by the terminal device. of the network device on Mⱼ antenna ports corresponding to CSI #j in CSI #j.

In at least one embodiment of the first aspect and the second aspect, that the i^{th} combination matrix is used for combining the N antenna ports into the Mᵢ antenna ports means that the i^{th} combination matrix is used for combining second channel vectors into the first channel vector on the Mᵢ antenna ports, and the second channel vectors are channel vectors that are on the N antenna ports and that are obtained based on the measurement results on the N antenna ports. Based on this implementation, one combination matrix is used for obtaining a channel vector in one channel shutdown pattern.

In at least one embodiment of the first aspect and the second aspect, the N antenna ports are grouped into N₂ antenna port groups, N₂ is an integer greater than 1, different antenna port groups in the N₂ antenna port groups correspond to different time domain positions, each antenna port group in the N₂ antenna port groups includes N₃ antenna ports, N₃ is a positive integer, and N=N_{2×}N₃. Based on this implementation, the antenna ports are grouped, and different antenna port groups correspond to different time domain positions, so that in response to the network device sending the reference signal in the N₂ antenna port groups, analog channel subarray switching is more easily implemented.

In at least one embodiment of the first aspect and the second aspect, N₂₌N₁; or N₂/N₁ is an integer greater than 1. Based on this implementation, one reference signal corresponds to one antenna port group, or a plurality of antenna port groups corresponds to one reference signal. This helps reduce reference signal overheads.

In at least one embodiment of the first aspect and the second aspect, the second channel vector is H₂, the i^{th} first channel vector is H₁ᵢ, H₁ᵢ=Aᵢ×H₂. Aᵢ is the i^{th} combination matrix, and Aᵢ=[a_{m,n}]_{1≤m≤M}_{ᵢ}_{, 1≤n≤N}, where a_{m,n} is an element in an m^{th} row and an n^{th} column of the combination matrix Aᵢ. Optionally, a_{m,n} represents a combination weight from an n^{th} antenna port in the N antenna ports to an m^{th} combined port in the Mᵢ antenna ports. Based on this implementation, a channel vector in a channel shutdown pattern corresponding to a combination matrix is accurately determined.

In at least one embodiment of the first aspect and the second aspect, a_{m,n} is 1 or 0; or a_{m,n} is 0 or aₘ, and aₘ is protocol-predefined or aₘ is configured by the network device.

In at least one embodiment of the first aspect and the second aspect, a_{m,n1} and a_{m,n2} exist in Aᵢ, a_{m,n1}>0, a_{m,n2}>0, and n1 is not equal to n2. Based on this implementation, one combined antenna port is to be obtained by combining at least two antenna ports in the N antenna ports.

In at least one embodiment of the first aspect and the second aspect, for n∉Sₘ, a_{m,n}=0, where Sₘ is a pre-combination port set corresponding to an m^{th} combined port, an intersection set of Sₘ₁ and Sₘ₂ is an empty set, and m₁ and m₂ are sequence numbers of any two different combined ports. Based on this implementation, different combined antenna ports are obtained by combining different antenna ports in the N antenna ports.

In at least one embodiment of the first aspect, first indication information is received from the network device, where the first indication information indicates the K₁ combination matrices. In this implementation, the K₁ combination matrices are not fixed, and is indicated by the network device. In this way, the terminal device more flexibly determines CSI in different channel shutdown patterns.

In at least one embodiment of the second aspect, first indication information is sent to the terminal device, where the first indication information indicates the K₁ combination matrices. In this implementation, the K₁ combination matrices are not fixed, and is indicated by the network device. In this way, the terminal device more flexibly determines CSI in different channel shutdown patterns.

In at least one embodiment of the first aspect and the second aspect, the K₁ combination matrices are K₁ combination matrices in K combination matrices, and the first indication information indicates sequence numbers of the K₁ combination matrices in a set including the K combination matrices, where the K combination matrices are protocol-predefined or indicated by the network device by using second indication information, and K is an integer greater than or equal to K₁. In this optional manner, the network device indicates a plurality of combination matrices to the terminal device in advance, and subsequently flexibly indicate, by using the first indication information and as used, a combination matrix to be used by the terminal device. Therefore, based on this implementation, flexibility of indicating the combination matrix by the network device is improved.

In at least one embodiment of the first aspect and the second aspect, K₂ is equal to K₁. To be specific, the terminal device feeds back all of CSI determined by the terminal device.

In at least one embodiment of the first aspect and the second aspect, K₂ is less than K₁, where
the K₂ pieces of CSI are K₂ pieces of CSI with a maximum utility function in the K₁ pieces of CSI, and the utility function of the CSI is related to a rank indicator RI and a channel quality indicator CQI in the CSI;
the K₂ pieces of CSI are one or more pieces of CSI with a utility function whose fallback value is less than or equal to a first threshold in the K₁ pieces of CSI, where a fallback value of a utility function of first CSI is a ratio of a utility function of second CSI to the utility function of the first CSI, the second CSI is CSI with a maximum utility function in the K₁ pieces of CSI, and the utility function of the CSI is related to an RI and a CQI in the CSI; or
the K₂ pieces of CSI are CSI with a minimum utility function in CSI with a utility function whose fallback value is less than or equal to a first threshold in the K₁ pieces of CSI, where a fallback value of a utility function of first CSI is a ratio of a utility function of second CSI to the utility function of the first CSI, the second CSI is CSI with a maximum utility function in the K₁ pieces of CSI, and the utility function of the CSI is related to an RI and a CQI in the CSI.

Based on this implementation, CSI reporting overheads is reduced.

In at least one embodiment of the first aspect and the second aspect, the Mᵢ combined antenna ports are in one-to-one correspondence with the Mᵢ digital channels, the N antenna ports are in one-to-one correspondence with the N analog channel subarrays, and one digital channel corresponds to one or more analog channel subarrays.

According to a third aspect, at least one embodiment provides a communication apparatus. The communication apparatus is a terminal device, an apparatus in the terminal device. or an apparatus that is used together with the terminal device. The communication apparatus is alternatively a chip system. The communication apparatus performs the method according to the first aspect. A function of the communication apparatus is implemented by hardware, or is implemented by hardware by executing corresponding software. The hardware or the software includes one or more units or modules corresponding to the function. The unit or the module is software and/or hardware. For operations performed by the communication apparatus and beneficial effects thereof, refer to the method in the first aspect and the beneficial effects thereof.

According to a fourth aspect, at least one embodiment provides a communication apparatus. The communication apparatus is a network device, an apparatus in the network device. or an apparatus that is used together with the network device. The communication apparatus is alternatively a chip system. The communication apparatus performs the method according to the second aspect. A function of the communication apparatus is implemented by hardware, or is implemented by hardware by executing corresponding software. The hardware or the software includes one or more units or modules corresponding to the function. The unit or the module is software and/or hardware. For operations performed by the communication apparatus and beneficial effects thereof, refer to the method in the second aspect and the beneficial effects thereof.

According to a fifth aspect, at least one embodiment provides a communication apparatus. The communication apparatus includes a processor and an interface circuit. The interface circuit is configured to: receive a signal from a communication apparatus other than the communication apparatus and transmit the signal to the processor, or send a signal from the processor to a communication apparatus other than the communication apparatus. The processor is configured to implement the method according to the first aspect or the second aspect by using a logic circuit or by executing code instructions.

According to a sixth aspect, at least one embodiment provides a computer-readable storage medium, where the storage medium stores a computer program or instructions, and in response to the computer program or the instructions being executed by a communication apparatus, the method according to the first aspect or the second aspect is implemented.

According to a seventh aspect, at least one embodiment provides a computer program product including instructions, in response to a communication apparatus reading and executing the instructions, the communication apparatus is enabled to perform the method according to any one of the first aspect or the second aspect.

According to an eighth aspect, at least one embodiment provides a communication system, including the communication apparatus configured to perform the method according to the first aspect and the communication apparatus configured to perform the method according to the second aspect.

### BRIEF DESCRIPTION OF DRAWINGS

FIG. 1 is a schematic diagram of an HBF architecture;

FIG. 2 is a schematic diagram of an analog channel subarray in an HBF architecture according to at least one embodiment;

FIG. 3 is a schematic diagram of a full aperture architecture according to at least one embodiment;

FIG. 4 is a schematic diagram of a mode of digital channel shutdown and antenna switching in a full aperture architecture according to at least one embodiment;

FIG. 5 is a schematic diagram of another mode of digital channel shutdown and antenna switching in a full aperture architecture according to at least one embodiment;

FIG. 6 is a schematic diagram of still another mode of digital channel shutdown and antenna switching in a full aperture architecture according to at least one embodiment;

FIG. 7 is a schematic diagram of still another mode of digital channel shutdown and antenna switching in a full aperture architecture according to at least one embodiment;

FIG. 8 is a schematic diagram of a communication system according to at least one embodiment;

FIG. 9 is a schematic flowchart of a channel state information feedback method according to at least one embodiment;

FIG. 10 is a schematic diagram of another HBF architecture according to at least one embodiment;

FIG. 11 is a schematic diagram of still another HBF architecture according to at least one embodiment;

FIG. 12 is a schematic flowchart of another channel state information feedback method according to at least one embodiment;

FIG. 13 is a schematic flowchart of still another channel state information feedback method according to at least one embodiment;

FIG. 14 is a schematic diagram of a structure of a communication apparatus according to at least one embodiment; and

FIG. 15 is a schematic diagram of a structure of another communication apparatus according to at least one embodiment.

### DESCRIPTION OF EMBODIMENTS

In at least one embodiment, the claims, and the accompanying drawings, terms “first”, “second”, and the like are intended to distinguish between different objects but do not describe a particular order. In addition, the terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

An “embodiment” mentioned herein means that a particular feature, structure, or characteristic described with reference to this embodiment is included in at least one embodiment. The phrase shown in various positions in at least one embodiment does not necessarily refer to a same embodiment, and is not an independent or optional embodiment exclusive from another embodiment. Embodiments described herein are able to be combined with another embodiment.

For ease of understanding related content in at least one embodiment, some concepts related to at least one embodiment are described.

1. Hybrid beamforming (HBF) architecture: In a high frequency, mainstream base station products all use the HBF architecture. To be specific, one digital channel corresponds to a plurality of analog channels, and each analog channel corresponds to one or more antenna elements.

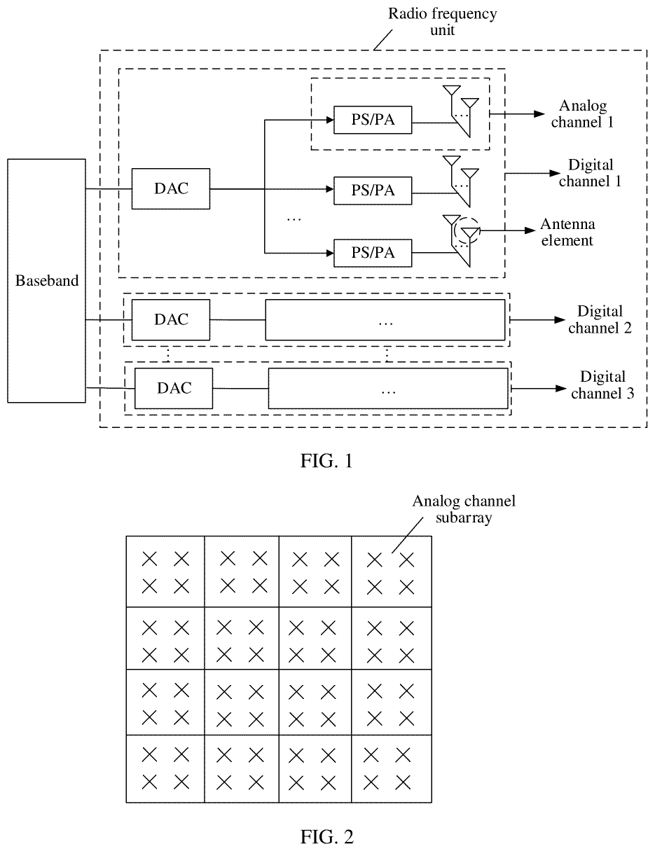

In this way, a quantity of digital channels is reduced, to reduce deployment costs and a size. FIG. 1 is a schematic diagram of an HBF architecture on a radio frequency unit of an mmWave base station. As shown in FIG. 1, the radio frequency unit includes a plurality of digital channels (digital chains), each digital channel is connected to a plurality of analog channels (analog chains), and each analog channel is connected to one or more antenna elements. FIG. 1 uses downlink transmission as an example. For the mmWave base station, a quantity of digital channels is generally small, for example, 4 or 8. and a quantity of analog channels associated with each digital channel is large, for example, 128 or 256. In at least one embodiment, a channel is also referred to as a link, and one channel includes a transmit channel and a receive channel.

2. Antenna element: The antenna element is a physical entity, a smallest physical entity for constituting an antenna array, and a smallest electromagnetic wave transmit unit. Generally, the antenna element is a half-wave element, an omnidirectional element, a dot element, a linear element, or a circular element.

3. Transmit and receive channel: The transmit and receive channel is a digital channel or an analog channel. The transmit and receive channel is a physical concept. One transmit and receive channel is usually associated with one or more antenna elements to form a 1-driving-N connection architecture. A mapping weight is set between the transmit and receive channel and the antenna elements. For example, the mapping weight is implemented by adjusting azimuths of the elements, or is implemented by adding a phase shifter and adjusting a phase of the phase shifter.

(1) Digital channel: One digital channel is associated with one ADC/DAC, and a quantity of digital channels indicates a quantity of antenna ports visible in digital domain. One-stream or multi-stream signals is mapped to the foregoing plurality of digital channels in digital domain, and different mapping manners is used at different frequency positions.

(2) Analog channel: The analog channel is mainly used in the HBF architecture. One digital channel is associated with one or more analog channels through the ADC/DAC. Signal processing between the digital channel and the analog channel is performed only in analog domain, and is implemented by using an analog device. For example, a filter is used for shaping, a PA is used for power amplification. and a phase shifter (PS) is used for phase adjustment. In addition, the processing is broadband. To be specific, different power amplification coefficients or phase adjustment coefficients cannot be added to different frequency positions.

4. Antenna port: The antenna port is a logical concept in a standard, and corresponds to one or more antenna elements. The digital channel is a physical concept. A quantity N of digital channels on one radio frequency unit is fixed. In different transmission processes, the radio frequency unit has different quantities of antenna ports. In other words, one antenna port is mapped to a subset of the foregoing N digital channels. Different antenna ports correspond to different virtual mapping manners. In the standard, different antenna ports correspond to different transport streams.

At least one embodiment mainly focuses on an antenna port of a downlink reference signal, for example, a channel state information-reference signal (CSI-RS) antenna port. Generally, although the CSI-RS antenna port is also a logical concept, in most scenarios, especially in an FDD system, during CSI measurement, the base station enables the CSI-RS antenna port and the digital channel on the radio frequency unit to be in one-to-one correspondence. In this way, UE obtains a channel matrix on each digital channel on the radio frequency unit by measuring a CSI-RS. However, the standard also supports sending a pre-coded CSI-RS. For example, the radio frequency unit has 32 digital channels, but sends 16-port CSI-RSs. Each CSI-RS port corresponds to one logical port, and each logical port is associated with one mapping vector of 1 to 32 digital channels. Currently, the pre-coded CSI-RSs are mostly used in a scenario in which a base station end has learned of information about some or all of channels. For example, in a TDD system, the base station has obtained a channel matrix based on an SRS.

5. Channel state information report configuration information: One CSI report is generally used for performing channel/interference measurement on a downlink frequency and feeding back corresponding CSI. The CSI report configuration information includes the following configurations.

(1) Report type configuration: For example. the report type configuration indicates periodic CSI (P-CSI), semi-persistent CSI (SP-CSI), or aperiodic CSI (A-CSI), and indicates information such as a periodicity configuration for reporting, a start offset value, or a trigger offset value.

(2) Feedback amount configuration: To be specific, the feedback amount configuration indicator (CRI), a synchronization signal/physical broadcast channel block resource indicator (SSBRI). a rank indicator (RI), a precoding matrix indicator (precoding matrix indicator, PMI), a channel quality indicator (CQI), a layer indicator (LI), a layer 1 reference signal received power (L1-RSRP). and a layer 1 signal to interference plus noise ratio (L1-SINR). The RI indicates a quantity of transport streams that is recommended by the UE and that is used in response to the base station performing data transmission, the PMI indicates a precoding matrix recommended, based on the quantity of transport streams, to be used, and the CQI indicates a modulation and coding scheme recommended. based on the quantity of transport streams and the precoding matrix, to be used. A preset block error rate is achieved by using the modulation and coding scheme. The LI notifies the base station of a stream with best received quality in the indicated transport streams. in response to the base station configuring a plurality of CSI-RSs or SSBs for CSI measurement, the CRI and the SSBRI indicate a resource that is notified by the UE to the base station and based on which current measurement is performed.

(3) Bandwidth configuration of the feedback amount: For example, each feedback amount is wideband feedback or narrow band feedback.

(4) Specific configuration information of each feedback amount: For example, the specific configuration information is a value restriction set of the RI, a codebook model of the PMI, and measurement table information of the CQI.

(5) Reference signal configuration information: The reference signal configuration information is used for configuring one or more reference signals.

6. CSI measurement: (1) One-shot measurement: One-shot measurement is to perform channel or interference measurement by using the latest reference signal, and calculate, based on a measurement result, CSI reported this time.

(2) Smooth measurement: For one CSI report. a smoothed measurement result is used to perform CSI calculation during channel measurement and interference measurement. Smooth measurement is to calculate, based on all measurement results of configured reference signals in time domain (where the reference signals are usually periodically or semi-persistently sent, and therefore there are a plurality of measurement results in time domain), CSI reported this time. A specific smooth solution is implemented by a terminal device.

7. Channel shutdown technology: From perspective of base station energy saving, in response to cell load being light, some digital channels or analog channels is selected to be closed to reduce power consumption of components on the channels. Currently, a channel shutdown technology on a base station side is classified into semi-static shutdown and dynamic shutdown.

(1) Semi-static channel shutdown: Generally, shutdown time is at a minute level or even an hour level. The base station uses a shutdown periodicity P. Then, based on current and previous service arrival conditions and a specific algorithm, a service arrival condition in a next time period P is predicted, and a channel shutdown pattern is selected. For example, half of channels, a quarter of channels, or three-quarters of channels are shut down or not shut down. Then, in the time period P, the base station sends and controls a reference signal/performs data transmission based on a channel configuration obtained after shutdown.

(2) Dynamic channel shutdown: Dynamic channel shutdown is also called on-demand antenna shutdown. A core idea of dynamic channel shutdown is that the base station maximizes, on a premise of ensuring a service transmission usage, an antenna shutdown proportion based on a traffic volume to be transmitted in a TTI, to obtain a maximum instantaneous energy saving gain without affecting user experience.

8. Channel shutdown in the HBF architecture: Channel shutdown in the HBF architecture is performed at a granularity of a digital channel or a granularity of an analog channel. In the HBF architecture, there are generally only four or eight digital channels, and each digital channel is associated with hundreds of analog channels. Therefore, analog channel shutdown provides shutdown at a finer granularity. For example, as shown in FIG. 2, analog channels associated with one digital channel is divided into 16 analog channel subarrays. One analog channel subarray includes one or more analog channels. Then, shutdown is performed at a unit of the analog channel subarray, and 16 shutdown levels is obtained. To be specific, zero analog channel subarrays, one analog channel subarray, . . . , and 16 analog channel subarrays is shut down, and 16 shutdown degrees are obtained in total. In addition, even in response to two subarrays being shut down, different subarray shutdown options correspond to different performance. In this way, there are more shutdown patterns in total, and a quantity is up to 216. More shutdown levels and combinations provides more degrees of freedom of shutdown, to balance and optimize system performance and an energy saving gain. In comparison with shutting down the digital channel, shutting down some analog channels for each digital channel does not reduce a quantity of digital ports visible to the base station and the terminal device, and therefore does not reduce a multiplexing capability of the base station (where the multiplexing capability of the base station is a quantity of streams that is superimposed and transmitted by the base station in a time-frequency resource in space domain). Therefore, spectral efficiency is reduced less.

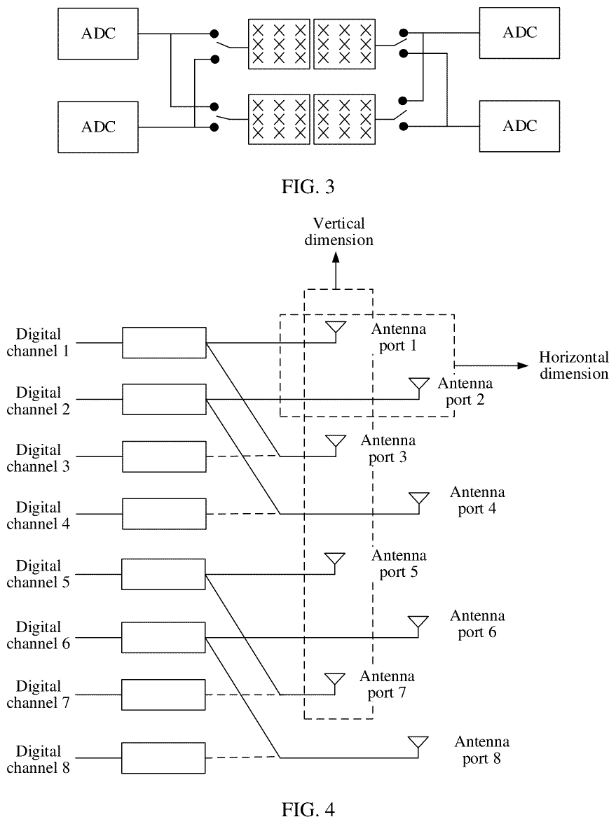

9. Antenna shutdown in a full aperture architecture: The full aperture architecture is also referred to as a full aperture array architecture. In a low frequency, one digital channel is associated with one analog channel. and antenna shutdown is performed only in digital domain. However, shutting down one digital channel not only means shutting down one PA, which causes a transmit power reduction (which is an expected energy saving effect), but also means shutting down an antenna element associated with the digital channel, which causes a loss of an antenna gain (where the antenna gain is generally referred to as a beamforming gain, and in response to a beam being aligned with the terminal device, the beamforming gain increases as an antenna array gain increases). To reduce the loss, an antenna shutdown method in the full aperture architecture is proposed in the industry. As shown in FIG. 3, in response to antennas corresponding to some digital channels being shut down, the antennas corresponding to the digital channels are switched to remaining digital channels, so that a quantity of available antenna elements is reserved to maintain a maximum antenna array gain.

For example, one low-frequency sending apparatus includes eight digital channels that correspond to eight antenna ports, and includes the following four modes of digital channel shutdown and antenna switching.

Mode 1: Shut down half of the channels in a vertical dimension, and switch the corresponding antennas to the remaining half of the channels in the vertical dimension, as shown in FIG. 4.

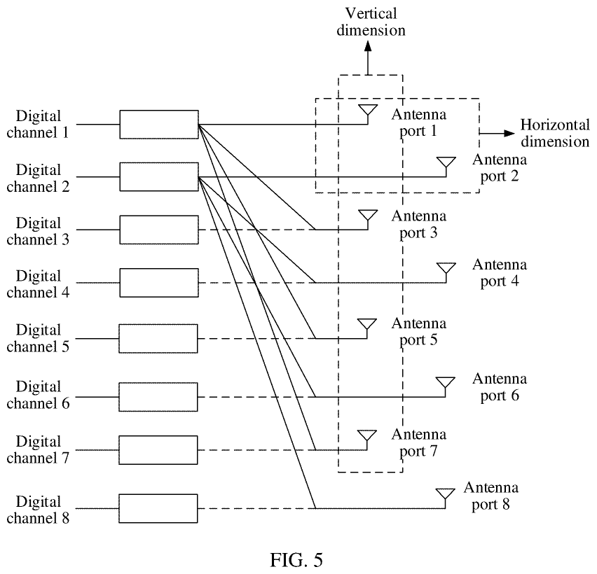

Mode 2: Shut down three-quarters of the channels in a vertical dimension, and switch the corresponding antennas to the remaining quarter of the channels in the vertical dimension, as shown in FIG. 5.

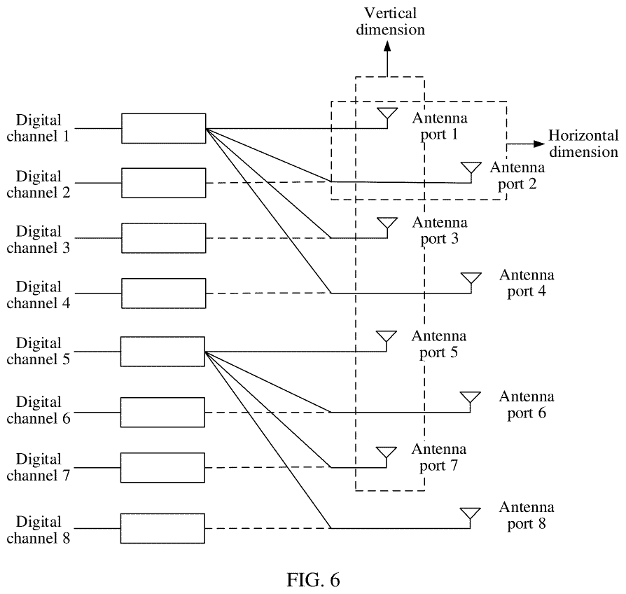

Mode 3: Shut down half of the channels in a vertical dimension and half of the channels in a horizontal dimension, and switch the corresponding antennas to the remaining quarter of the channels, as shown in FIG. 6.

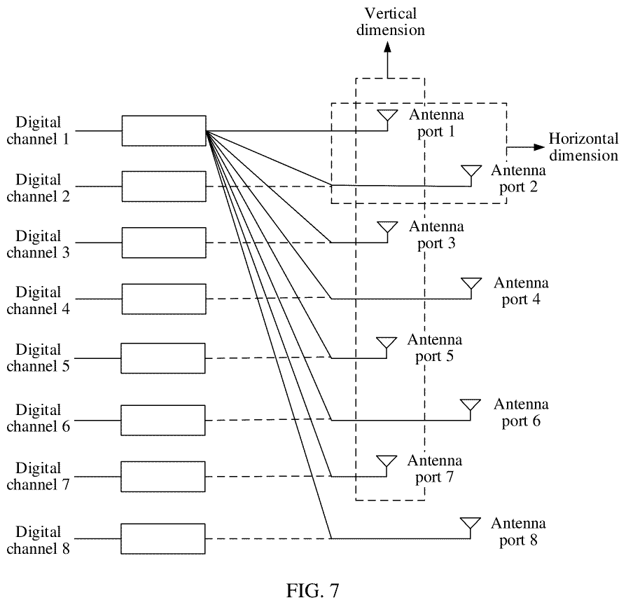

Mode 4: Shut down three-quarters of the channels in a vertical dimension and half of the channels in a horizontal dimension, and switch the corresponding antennas to the remaining one-eighth of the channels, as shown in FIG. 7.

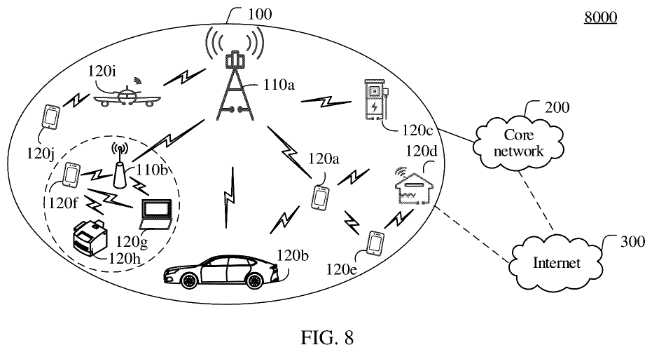

FIG. 8 is a schematic diagram of an architecture of a communication system 8000 to which at least one embodiment is applied. As shown in FIG. 8, the communication system includes a radio access network 100 and a core network 200. Optionally, the communication system 8000 further includes the Internet 300. The radio access network 100 includes at least one radio access network device (for example, 110a and 110b in FIG. 8), and further includes at least one terminal (for example, 120a to 120j in FIG. 8). The terminal is connected to the radio access network device in a wireless manner, and the radio access network device is connected to the core network in a wireless or wired manner. A core network device and the radio access network device is independent and different physical devices; functions of the core network device and logical functions of the radio access network device are integrated into a same physical device; or some functions of the core network device and some functions of the radio access network device are integrated into one physical device. The wired or wireless manner is used for connection between the terminals and between the radio access network devices. FIG. 8 is only a schematic diagram. The communication system further includes another network device, for example, further includes a wireless relay device and a wireless backhaul device, which are not shown in FIG. 8.

The radio access network device is a base station, an evolved NodeB (eNodeB), a transmission reception point (TRP), a next generation NodeB (gNB) in a 5^{th} generation (5G) mobile communication system, a next generation NodeB in a 6^{th} generation (6G) mobile communication system, a base station in a future mobile communication system, an access node in a Wi-Fi system, or the like; or the radio access network device is a module or unit that completes some functions of the base station, for example, is a central unit (CU), or is a distributed unit (DU). The CU herein completes functions of a radio resource control protocol and a packet data convergence protocol (PDCP) of the base station, and further completes a function of a service data adaptation protocol (SDAP). The DU completes functions of a radio link control layer and a medium access control (MAC) layer of the base station, and further completes functions of some or all of physical layers. For specific descriptions of the foregoing protocol layers, refer to related technical specifications of the 3^{rd} generation partnership project (3GPP). The radio access network device is a macro base station (for example, 110a in FIG. 8), or is a micro base station or an indoor station (for example, 110b in FIG. 8), or is a relay node or a donor node. A specific technology and a specific device form that are used by the radio access network device are not limited in at least one embodiment. In at least one embodiment, the radio access network device is referred to as a network device for short, and the base station is a specific example of the network device.

The terminal is also referred to as a terminal device, user equipment (UE), a mobile station, a mobile terminal, or the like. The terminal is widely applied to various scenarios such as device-to-device (D2D), vehicle-to-everything (V2X) communication, machine type communication (MTC), an internet of things (IoT), virtual reality, augmented reality, industrial control, self-driving, telemedicine, a smart grid, smart furniture, smart working, smart wearing, smart transportation, and a smart city. The terminal is a mobile phone, a tablet computer, a computer with a wireless transceiver function, a wearable device, a vehicle, an unmanned aerial vehicle, a helicopter, an airplane, a ship, a robot, a robot arm, a smart home device, or the like. A specific technology and a specific device form used by the terminal are not limited in at least one embodiment.

The base station and the terminal are located at a fixed position, or is mobile. The base station and the terminal are deployed on land, including an indoor or outdoor device, a handheld device, or a vehicle-mounted device, is deployed on water, or is deployed on an airplane, a balloon. or a satellite in air. Application scenarios of the base station and the terminal are not limited in at least one embodiment.

Roles of the base station and the terminal is relative. For example, the helicopter or the unmanned aerial vehicle 120i in FIG. 8 is configured as a mobile base station. For the terminals 120j that access the radio access network 100 via 120i. the terminal 120i is a base station. However, for the base station 110a. 120i is a terminal. In other words. 110a and 120i communicate with each other by using a wireless air interface protocol. Terminals 110a and 120i alternatively communicate with each other by using an interface protocol between base stations. In this case,

for 110a. 120i is also a base station. Therefore, both the base station and the terminal is collectively referred to as communication apparatuses, 110a and 110b in FIG. 8 is referred to as communication apparatuses having a base station function, and 120a to 120j in FIG. 8 is referred to as communication apparatuses having a terminal function.

Communication between the base station and the terminal, between the base stations, and between the terminals is performed by using a licensed spectrum, or is performed by using an unlicensed spectrum, or is performed by using both the licensed spectrum and the unlicensed spectrum. Communication is performed by using a spectrum below 6 gigahertz (GHz), or is performed by using a spectrum above 6 GHz, or is performed by using both the spectrum below 6 GHz and the spectrum above 6 GHz. A spectrum resource used for wireless communication is not limited in at least one embodiment.

In at least one embodiment, a function of the base station is alternatively performed by a module (for example, a chip) in the base station, or is performed by a control subsystem including the base station function. The control subsystem including the base station function herein is a control center in the foregoing application scenarios such as the smart grid, the industrial control, the smart transportation, and the smart city. A function of the terminal is alternatively performed by a module (for example, a chip or a modem) in the terminal, or is performed by an apparatus including the terminal function.

In at least one embodiment, the base station sends a downlink signal or downlink information to the terminal, where the downlink information is carried on a downlink channel; and the terminal sends an uplink signal or uplink information to the base station, where the uplink information is carried on an uplink channel. To communicate with the base station, the terminal establishes a wireless connection to a cell controlled by the base station. The cell that establishes the wireless connection to the terminal is referred to as a serving cell of the terminal, in response to communicating with the serving cell, the terminal is further interfered by a signal from a neighboring cell.

In at least one embodiment, a radio frequency unit of the base station uses an HBF architecture or a full aperture architecture, in response to the base station using the HBF architecture, the radio frequency unit performs dynamic antenna shutdown at a granularity of an analog channel. in response to the base station using the full aperture architecture, the radio frequency unit performs dynamic antenna shutdown at a granularity of a digital channel.

The following further describes in detail a channel state information feedback method and a communication apparatus that are provided in at least one embodiment.

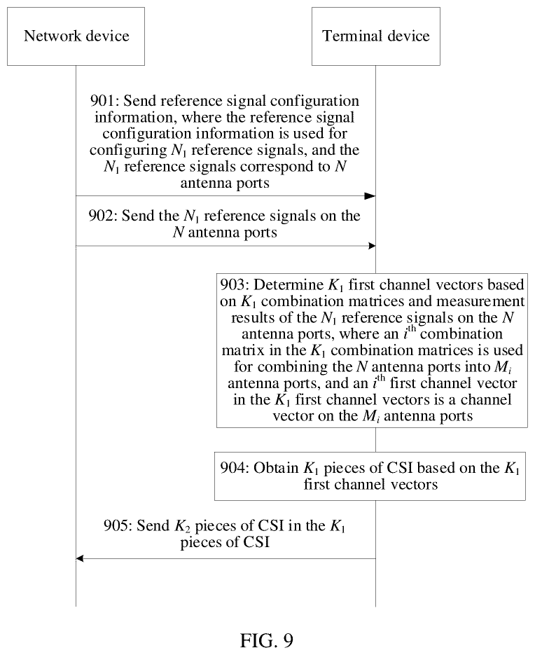

FIG. 9 is a schematic flowchart of a channel state information feedback method according to at least one embodiment. As shown in FIG. 9, the channel state information feedback method includes the following step 901 to step 905. The method shown in FIG. 9 is performed by a terminal device and a network device, or the method shown in FIG. 9 is performed by a chip in the terminal device and a chip in the network device. In addition, in at least one embodiment, measurement results of one or more reference signals on a plurality of antenna ports correspond to one channel vector, namely, a channel vector corresponding to a plurality of transmit antenna ports on one receive antenna. Alternatively, a plurality of receive antennas are also able to be used. Each receive antenna corresponds to one channel vector, and channel vectors on all of the receive antennas are sometimes referred to as channel matrices. An example in which the method is performed by the terminal device and the network device is used for description in FIG. 9.

901: The network device sends reference signal configuration information to the terminal device, where the reference signal configuration information is used for configuring N₁ reference signals. N₁ is a positive integer, the N₁ reference signals correspond to N antenna ports, and N is an integer greater than 1. Correspondingly the terminal device receives the reference signal configuration information from the network device.

The reference signal is a CSI-RS or another downlink reference signal, for example, a synchronization signal/physical broadcast channel block (SSB). The reference signal configuration information is in channel state information report (CSI report) configuration information. For descriptions of the CSI report configuration information, refer to the foregoing descriptions of the CSI report configuration information.

In at least one embodiment, a radio frequency unit of the network device uses an HBF architecture. Analog channels associated with each digital channel are divided into one or more analog channel subarrays. One analog channel subarray includes one or more analog channels. The radio frequency unit of the network device has N analog channel subarrays in total. The N antenna ports are in one-to-one correspondence with the N analog channel subarrays. That an analog channel subarray corresponds to an antenna port indicates that a signal on the antenna port is sent by using the analog channel subarray.

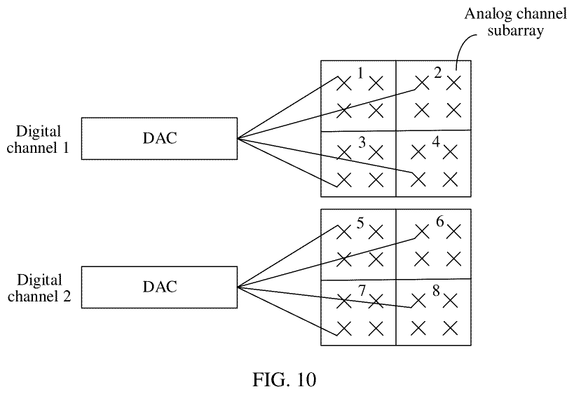

For example, as shown in FIG. 10, the radio frequency unit of the network device includes two digital channels. A digital channel 1 is associated with four analog channel subarrays, which are respectively an analog channel subarray 1 to an analog channel subarray 4. A digital channel 2 is associated with four analog channel subarrays, which are respectively an analog channel subarray 5 to an analog channel subarray 8. In this scenario, a plurality of antenna ports is virtualized on one digital channel. The analog channel subarray 1 corresponds to an antenna port 1, the analog channel subarray 2 corresponds to an antenna port 2, . . . , and the analog channel subarray 8 corresponds to an antenna port 8.

In at least one embodiment, the N antenna ports are grouped into N₂ antenna port groups, where N₂ is an integer greater than 1, different antenna port groups in the N₂ antenna port groups correspond to different time domain positions, each antenna port group in the N₂ antenna port groups include N₃ antenna ports, and N=N₂×N₃.

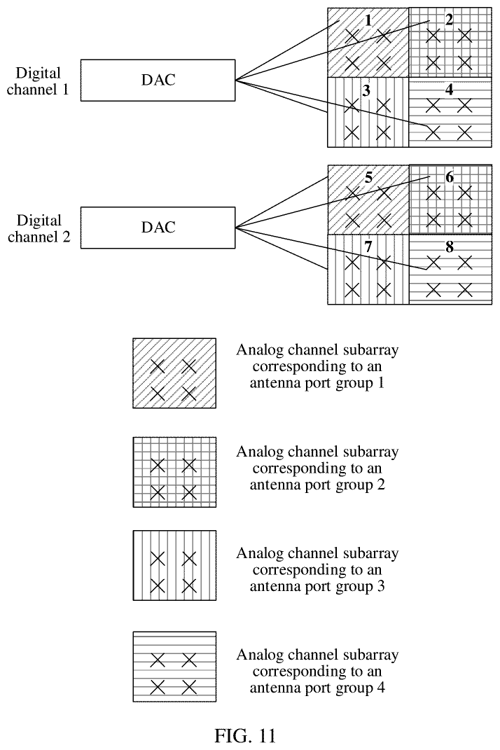

For example, as shown in FIG. 11, N is 8., and the analog channel subarray 1 to the analog channel subarray 8 respectively correspond to the antenna port 1 to the antenna port 8. N₂ is 4. To be specific, N₂ is equal to a quantity of analog channel subarrays associated with one digital channel. The antenna port 1 and the antenna port 5 is grouped into an antenna port group 1. The antenna port 2 and the antenna port 6 are grouped into an antenna port group 2. The antenna port 3 and the antenna port 7 are grouped into an antenna port group 3. The antenna port 4 and the antenna port 8 are grouped into an antenna port group 4. The antenna port group 1 to the antenna port group 4 respectively correspond to different time domain positions. In other words, each digital channel is sequentially mapped to four analog channel subarrays through time division switching. Alternatively, N₂ is less than a quantity of analog channel subarrays associated with one digital channel. This is not limited in at least one embodiment. The antenna ports are grouped, and different antenna port groups correspond to different time domain positions, so that in response to the network device sending the reference signals on the N antenna ports, analog channel subarray switching is implemented more easily.

Optionally, there are the following three relationships between N₂ and N₁.

(1) N₂=N₁. To be specific, one reference signal corresponds to one antenna port group. in other words. the reference signal is sent on the antenna port group. For example, a CSI-RS 1 corresponds to the antenna port group 1, in other words, the CSI-RS I is sent on the antenna port group 1. A CSI-RS 2 corresponds to the antenna port group 2, in other words, the CSI-RS 2 is sent on the antenna port group 2. A CSI-RS 3 corresponds to the antenna port group 3, in other words, the CSI-RS 3 is sent on the antenna port group 3. A CSI-RS 4 corresponds to the antenna port group 4, in other words, the CSI-RS 4 is sent on the antenna port group 4.

(2) N₂/N₁ is an integer greater than 1. To be specific, one reference signal corresponds to a plurality of antenna port groups, in other words, the reference signal is sent on the plurality of antenna port groups. For example, in response to N₂ being 4, and N₁ being 1, one reference signal corresponds to four antenna port groups, in other words. the reference signal is sent on the four antenna port groups. For another example, in response to N₂ being 4, and N₁ being 2, a reference signal 1 corresponds to the antenna port group 1 and the antenna port group 2, in other words, the reference signal 1 is sent on the antenna port group 1 and the antenna port group 2; and a reference signal 2 corresponds to the antenna port group 3 and the antenna port group 4. in other words, the reference signal 2 is sent on the antenna port group 3 and the antenna port group 4. Based on this implementation, the plurality of antenna port groups corresponds to one reference signal. This helps reduce reference signal overheads.

(3) N₁/N₂ is an integer greater than 1. To be specific, one antenna port group corresponds to a plurality of reference signals, in other words, the plurality of reference signals is sent on the antenna port group. For example, in response to N₂ being 4, and N₁ being 8, the antenna port group 1 corresponds to a reference signal 1 and a reference signal 2, in other words, the reference signal 1 and the reference signal 2 are respectively sent on the antenna port 1 and the antenna port 5 in the antenna port group 1; the antenna port group 2 corresponds to a reference signal 3 and a reference signal 4, in other words, the reference signal 3 and the reference signal 4 are respectively sent on the antenna port 2 and the antenna port 6 in the antenna port group 2; the antenna port group 3 corresponds to a reference signal 5 and a reference signal 6, in other words, the reference signal 5 and the reference signal 6 are respectively sent on the antenna port 3 and the antenna port 7 in the antenna port group 3; and the antenna port group 4 corresponds to a reference signal 7 and a reference signal 8, in other words, the reference signal 7 and the reference signal 8 are respectively sent on the antenna port 4 and the antenna port 8 in the antenna port group 4.

In at least one embodiment, a radio frequency unit of the network device uses a full aperture architecture. The radio frequency unit of the network device has N digital channels in total. The N antenna ports are in one-to-one correspondence with the N digital channels. For example, N is 8, and the digital channel I to the digital channel 8 in FIG. 4 to FIG. 7 respectively correspond to an antenna port 1 to an antenna port 8.

In at least one embodiment, the network device further sends indication information to the terminal device, where the indication information indicates to combine the N antenna ports. Correspondingly, the terminal device receives the indication information. After receiving the indication information, the terminal device subsequently performs port combination based on a combination matrix. Based on this implementation, the terminal device performs antenna port combination only in response to the network device indicating the terminal device to perform antenna port combination, and the terminal device does not combine the antenna ports by default. This is more flexible.

Optionally, the indication information and the reference signal configuration information is included in a same piece of CSI report configuration information; or the indication information and the reference signal configuration information are not included in a same piece of CSI report configuration information, in other words, the indication information and the reference signal configuration information are separately sent.

902: The network device sends the N₁ reference signals on the N antenna ports.

In at least one embodiment, after sending the reference signal configuration information to the terminal device, the network device sends the N₁ reference signals on the N antenna ports. Correspondingly, the terminal device measures the N₁ reference signals sent on the N antenna ports.

903: The terminal device determines K₁ first channel vectors based on K₁ combination matrices and measurement results of the N₁ reference signals on the N antenna ports, where an i^{th} combination matrix in the K₁ combination matrices is used for combining the N antenna ports into Mᵢ antenna ports, an i^{th} first channel vector in the K₁ first channel vectors is a channel vector on the Mᵢ antenna ports, Mᵢ is less than or equal to N, Mᵢ is a positive integer, K₁ is a positive integer, and 1≤i≤K₁.

In at least one embodiment, after receiving the reference signal configuration information from the network device, the terminal device determines the K₁ first channel vectors based on the K₁ combination matrices and the measurement results of the N₁ reference signals on the N antenna ports. Optionally, the combination matrix is also referred to as another name, for example, a port combination matrix, a channel combination matrix, a port mapping matrix, or a port mapping table.

In at least one embodiment, one combination matrix corresponds to one channel shutdown pattern.

In at least one embodiment, the Mᵢ antenna ports correspond to Mᵢ digital channels, the N antenna ports correspond to N analog channel subarrays, and Mᵢ is less than N.

For example, the radio frequency unit of the network device uses the HBF architecture. K₁ is 2. A combination matrix 1 corresponds to a channel shutdown pattern 1, and a combination matrix 2 corresponds to a channel shutdown pattern 2. The channel shutdown pattern 1 is used to shut down the antenna port 1 and the antenna port 5 in FIG. 11, and the channel shutdown pattern 2 is used to shut down the antenna port 1 and the antenna port 8 in FIG. 11.

The combination matrix 1 is used for combining the antenna port 2 to the antenna port 4 into an antenna port A, and is used for combining the antenna port 6 to the antenna port 8 into an antenna port B. The combined antenna port A corresponds to a digital channel 1, and the combined antenna port B corresponds to a digital channel 2. The terminal device determines a first channel vector H_{1,1} on the antenna port A and the antenna port B based on the combination matrix 1 and reference signal measurement results on the antenna port 1 to the antenna port 8. The terminal device obtains CSI in the channel shutdown pattern 1 based on the first channel vector H_{1,1}.

Similarly, the combination matrix 2 is used for combining the antenna port 2 to the antenna port 4 into an antenna port A, and is used for combining the antenna port 5 to the antenna port 7 into an antenna port B. The combined antenna port A corresponds to a digital channel 1, and the combined antenna port B corresponds to a digital channel 2. The terminal device determines a first channel vector H_{1,2} on the antenna port A and the antenna port B based on the combination matrix 2 and reference signal measurement results on the antenna port 1 to the antenna port 8. The terminal device obtains CSI in the channel shutdown pattern 2 based on the first channel vector H_{1,2}.

In at least one embodiment, the Mᵢ antenna ports correspond to Mᵢ remaining activated digital channels in one digital channel shutdown pattern, the N antenna ports correspond to all of the N digital channels, and Mᵢ is less than N.

For example, the radio frequency unit of the network device uses the full aperture architecture. K₁ is 2. A combination matrix 1 corresponds to a channel shutdown pattern 3, and a combination matrix 2 corresponds to a channel shutdown pattern 4. The channel shutdown pattern 1 is the channel shutdown pattern shown in FIG. 4, and the channel shutdown pattern 2 is the channel shutdown pattern shown in FIG. 5.

The combination matrix I is used for combining the antenna port 1 and the antenna port 3 into an antenna port A, is used for combining the antenna port 2 and the antenna port 4 into an antenna port B, is used for combining the antenna port 5 and the antenna port 7 into an antenna port C, and is used for combining the antenna port 6 and the antenna port 8 into an antenna port D. The antenna port A corresponds to a digital channel 1, the antenna port B corresponds to a digital channel 2, the antenna port C corresponds to a digital channel 5, and the antenna port D corresponds to a digital channel 6. The terminal device determines a first channel vector H_{1,1} on the antenna port A to the antenna port D based on the combination matrix 1 and reference signal measurement results on the antenna port 1 to the antenna port 8. The terminal device obtains CSI in the channel shutdown pattern I based on the first channel vector H_{1,1}.

Similarly, the combination matrix 2 is used for combining the antenna port 1, the antenna port 3, the antenna port 5, and the antenna port 7 into an antenna port A, and the combination matrix 2 is used for combining the antenna port 2, the antenna port 4, the antenna port 6, and the antenna port 8 into an antenna port B. The antenna port A corresponds to a digital channel 1, and the antenna port B corresponds to a digital channel 2. The terminal device determines a first channel vector H_{1,2} on the antenna port A and the antenna port B based on the combination matrix 2 and reference signal measurement results on the antenna port 1 to the antenna port 8. The terminal device obtains CSI in the channel shutdown pattern 2 based on the first channel vector H_{1,2}.

In at least one embodiment, K₁ pieces of CSI include CSI #j, the CSI #j includes a precoding matrix indicator PMI, and the PMI is used for determining a precoding matrix, recommended by the terminal device, of the network device on Mⱼ antenna ports corresponding to the CSI #j in the CSI #j.

In at least one embodiment, quantities of combined antenna ports corresponding to different combination matrices is the same or different.

For example, the radio frequency unit of the network device uses the HBF architecture. in response to K₁ being 2, M₁=M₂.

For another example, the radio frequency unit of the network device uses the full aperture architecture, in response to K₁ being 2, the combination matrix 1 corresponds to the channel shutdown pattern shown in FIG. 4, and the combination matrix 2 corresponds to the channel shutdown pattern shown in FIG. 5, M₁≠M₂, where M₁=4, and M₂=2.

For another example, the radio frequency unit of the network device uses the full aperture architecture, in response to K₁ being 2, the combination matrix 1 corresponds to the channel shutdown pattern shown in FIG. 5, and the combination matrix 2 corresponds to the channel shutdown pattern shown in FIG. 6, M₁=M₂, where M₁=2, and M₂=2.

In at least one embodiment, the i^{th} combination matrix Aᵢ is represented as: Aᵢ=[a_{m,n}]_{1≤m≤M}_{ᵢ}_{, 1≤n≤N}, where a_{m,n} is an element in an m^{th} row and an n^{th} column of the combination matrix Aᵢ. Optionally, a_{m,n} represents a combination weight from an n^{th} antenna port in the N antenna ports to an m^{th} combined port in the Mᵢ antenna ports.

Optionally, for a_{m,n}, there are the following several cases.

(1) a_{m,n} is 1 or 0. in response to a_{m,n} being 0, the n^{th} antenna port does not participate in combination; or in response to a_{m,n} being 1, the n^{th} antenna port participates in combination.

For example, N=8 and Mᵢ=2. With reference to FIG. 11,

$${A}_{i} = [ \begin{matrix}1 & 0 & 0 & 0 & 0 & 0 & 0 & 0 \\ 0 & 0 & 0 & 0 & 1 & 0 & 0 & 0\end{matrix} ] ,$$

and the terminal device considers that only the antenna port 1 and the antenna port 5 finally send data, and CSI of the two antenna ports is measured. In other words, in the HBF architecture shown in FIG. 11, only the 1^{st} analog channel subarray is reserved for each digital channel, and other analog channel subarrays are shut down.

For another example, N=8 and Mᵢ=2 . With reference to FIG. 11,

$${A}_{i} = [ \begin{matrix}1 & 1 & 0 & 0 & 0 & 0 & 0 & 0 \\ 0 & 0 & 0 & 0 & 1 & 1 & 0 & 0\end{matrix} ] ,$$

and the 1^{st} antenna port and the 2^{nd} antenna port are combined into one antenna port, and the 5th antenna port and the 6^{th} antenna port are combined into one antenna port. The network device sends data through the two combined antenna ports. Therefore, the terminal device measures CSI of the two combined antenna ports. In other words, in the HBF architecture shown in FIG. 11, only the 1^{st} analog channel subarray and the 2^{nd} analog channel subarray that correspond to each digital channel are reserved for the digital channel, and other analog channel subarrays are closed.

For another example, N=8 and Mᵢ=2. With reference to FIG. 11,

$${A}_{i} = [ \begin{matrix}1 & 0 & 1 & 0 & 0 & 0 & 0 & 0 \\ 0 & 0 & 0 & 0 & 1 & 0 & 1 & 0\end{matrix} ] ,$$

and the 1^{st} antenna port and the 3^{rd} antenna port are combined into one antenna port, and the 5^{th} antenna port and the 7^{th} antenna port are combined into one antenna port. The network device sends data through the two combined antenna ports. Therefore, the terminal device measures CSI of the two combined antenna ports. In other words, in the HBF architecture shown in FIG. 11, only the 1^{st} analog channel subarray and the 3^{rd} analog channel subarray that correspond to each digital channel are reserved for the digital channel, and other analog channel subarrays are closed.

For another example, N=8 and Mᵢ=2. With reference to FIG. 11,

$${A}_{i} = [ \begin{matrix}1 & 1 & 1 & 0 & 0 & 0 & 0 & 0 \\ 0 & 0 & 0 & 0 & 1 & 1 & 1 & 0\end{matrix} ] ,$$

and the 1^{st} antenna port, the 2^{nd} antenna port, and the 3^{rd} antenna port are combined into one antenna port, and the 5^{th} antenna port, the 6^{th} antenna port, and the 7^{th} antenna port are combined into one antenna port. The network device sends data through the two combined antenna ports. Therefore, the terminal device measures CSI of the two combined antenna ports. In other words, in the HBF architecture shown in FIG. 11, only the 1^{st} analog channel subarray; the 2^{nd} analog channel subarray, and the 3^{rd} analog channel subarray that correspond to each digital channel are reserved for the digital channel, and the 4^{th} analog channel subarray is closed.

For another example, N=8 and Mᵢ=2. With reference to FIG. 11,

$${A}_{i} = [ \begin{matrix}1 & 1 & 1 & 1 & 0 & 0 & 0 & 0 \\ 0 & 0 & 0 & 0 & 1 & 1 & 1 & 1\end{matrix} ] ,$$

and the 1^{st} antenna port, the 2^{nd} antenna port, the 3^{rd} antenna port, and the 4^{th} antenna port are combined into one antenna port, and the 5^{th} antenna port, the 6^{th} antenna port, the 7^{th} antenna port, and the 8^{th} antenna port are combined into one antenna port. The network device sends data through the two combined antenna ports. Therefore, the terminal device measures CSI of the two combined antenna ports. In other words, in the HBF architecture shown in FIG. 11, no analog channel subarrays are closed for each digital channel.

(2) a_{m,n} is 0 or aₘ, aₘ is protocol-predefined, or aₘ is configured for the terminal device by using signaling after being determined by the network device. For example,

$${α}_{m} = \frac{1}{\sqrt{{\sum }_{n = 0}^{N} {α}_{m , n}}} .$$

in response to a_{m,n} being 0, the n^{th} antenna port does not participate in combination; or in response to a_{m,n} being aₘ, the n^{th} antenna port participates in combination, and a total transmit power of antenna ports participating in combination is normalized.

In at least one embodiment, a_{m,n1} and a_{m,n2} exist in Aᵢ, a_{m,n1}1>0, a_{m,n2}>0, and n1 is not equal to n2. In other words, one combined antenna port is to be obtained by combining at least two antenna ports in the N antenna ports.

For example,

$${A}_{i} = [ \begin{matrix}1 & 1 & 0 & 0 & 0 & 0 & 0 & 0 \\ 0 & 0 & 0 & 0 & 1 & 1 & 0 & 0\end{matrix} ] ,$$

and the 1^{st} antenna port and the 2^{nd} antenna port are combined into an antenna port A, and the 5^{th} antenna port and the 6^{th} antenna port are combined into an antenna port B. That is, the antenna port A is obtained by combining two antenna ports, and the antenna port B is obtained by combining two antenna ports.

In at least one embodiment, for n∉Sₘ, a_{m,n}=0, where Sₘ is a pre-combination port set corresponding to an m^{th} combined port, an intersection set of Sₘ₁ and Sₘ₂ is an empty set, and m₁ and m₂ are sequence numbers of any two different combined ports. In other words, different combined antenna ports are obtained by combining different antenna ports in the N antenna ports.

For example,

$${A}_{i} = [ \begin{matrix}1 & 1 & 0 & 0 & 0 & 0 & 0 & 0 \\ 0 & 0 & 0 & 0 & 1 & 1 & 0 & 0\end{matrix} ] ,$$

and the 1^{st} antenna port and the 2^{nd} antenna port are combined into an antenna port A, and the 5^{th} antenna port and the 6^{th} antenna port are combined into an antenna port B. That is, the antenna port A and the antenna port B are obtained by combining different antenna ports.

In at least one embodiment, the N ports form an all-1 vector x=[1,1, . . . ,1]^{T} whose length is N. The Mᵢ combined antenna ports is represented as a vector y=[y₁, y₂, . . . , y_{M}_{ᵢ}]^{T}=Aᵢx.

In at least one embodiment, that the i^{th} combination matrix is used for combining the N antenna ports into the Mᵢ antenna ports means that the i^{th} combination matrix is used for combining second channel vectors into the first channel vector on the Mᵢ antenna ports, and the second channel vectors are channel vectors that are on the N antenna ports and that are obtained based on the measurement results on the N antenna ports. Based on this implementation, one combination matrix is used for obtaining a channel vector in one channel shutdown pattern.

For example, assuming that the terminal device has only one receive port, the second channel vector on the N antenna ports is represented as a channel vector H₂=[h₁, . . . , h_{N}]^{T} whose length is N, where hₙ represents a channel gain on the n^{th} antenna port, and is a complex number, and 1≤n≤N. Optionally, the terminal device sorts the N antenna ports according to a preset rule, to obtain H₂=[h₁, . . . , h_{N}]^{T}.

In at least one embodiment, the second channel vector is H₂, the i^{th} combination matrix is Aᵢ, the i^{th} first channel vector is H_{1,i}, and H_{1,i}=Aᵢ×H₂. Based on this implementation, a channel vector in a channel shutdown pattern corresponding to a combination matrix is accurately obtained.

In at least one embodiment, the combination matrix is further represented in another method. For example, the reference signal configuration information carries grouping information of the N antenna ports. For example, the N antenna ports are grouped into L groups. Optionally, one antenna port belongs to a maximum of one group. The combination matrix is represented as a combination of L combination patterns. An l^{th} combination pattern is a combination vector, and is used for combining an l^{th} group of antenna ports into one antenna port. In this way, a quantity of finally combined antenna ports is fixed to L. In comparison with the foregoing general combination matrix, each combined antenna port herein is obtained by combining only a corresponding group of antenna ports.

For example, an antenna port 1 to an antenna port 4 corresponding to an analog channel 1 to an analog channel 4 in FIG. 10 is grouped into an antenna port group 1, and an antenna port 5 to an antenna port 8 corresponding to an analog channel 5 to an analog channel 8 is grouped into an antenna port group 2. The combination matrix is represented as a combination of two combination patterns. The 1^{st} combination pattern is used for combining the antenna port group 1 into one antenna port. For example, the 1^{st} combination pattern is P₁=[1110], and the antenna port 1 to the antenna port 3 are combined into one antenna port. The 2^{nd} combination pattern is used for combining the antenna port group 2 into one antenna port. For example, the 2^{nd} combination pattern is P₂=[1110], and the antenna port 5 to the antenna port 7 are combined into one antenna port.

In at least one embodiment, the network device further sends first indication information to the terminal device, where the first indication information indicates the K₁ combination matrices. Correspondingly, the terminal device further receives the first indication information. In this implementation, the K₁ combination matrices are not fixed, and is indicated by the network device. In this way, the terminal device more flexibly determines CSI in different channel shutdown patterns. Alternatively, the K₁ combination matrices is protocol pre-specified, and is not to be indicated by the network device.

Optionally, the first indication information is in medium access control-control element (MAC-CE) signaling or downlink control information (DCI) signaling. Alternatively, the first indication information is in the CSI report configuration information.

Optionally, the K₁ combination matrices are a subset of K combination matrices, and the first indication information indicates sequence numbers of the K₁ combination matrices in a set including the K combination matrices, where the K combination matrices are protocol-predefined or indicated by the network device by using second indication information, and K is an integer greater than or equal to K₁.

In this optional manner, the network device indicates a plurality of combination matrices to the terminal device in advance, and subsequently flexibly indicate, by using the first indication information and as used, a combination matrix to be used by the terminal device. Therefore, in this optional manner, the first indication information is in the MAC-CE signaling or the DCI signaling. In this way, flexibility of indicating the combination matrix by the network device is also improved.

Optionally, the reference signal configuration information and the second indication information is simultaneously sent. For example, both the reference signal configuration information and the second indication information are included in the CSI report configuration information. For example, one piece of CSI report configuration information includes the reference signal configuration information and the second indication information. The second indication information is used for configuring K=10 combination matrices. The network device indicates sequence numbers of four combination matrices to the terminal device by using one piece of MAC-CE signaling or one piece of DCI signaling. The terminal device selects K₁=4 combination matrices from the K=10 combination matrices to calculate CSI, and reports the CSI.

Optionally, in response to the reference signal configuration information being used for configuring one reference signal, that is, N₁=1, the second indication information is in the reference signal configuration information.

Alternatively, the second indication information is included in information other than the CSI report configuration information and sent to the terminal device. This is not limited in at least one embodiment.

904: The terminal device obtains the K₁ pieces of CSI based on the K₁ first channel vectors.

The CSI includes one or more of a CRI, an SSBRI, an RI, a PMI, a CQI, an LI, an L1-RSRP, and an L1-SINR. For descriptions of the CRI, the SSBRI, the RI, the PMI, the CQI, and the LI, refer to the foregoing related descriptions. Details are not described herein again. In at least one embodiment, the terminal device performs one-shot measurement or smooth measurement on the reference signal to obtain the K₁ pieces of CSI. For descriptions of one-shot measurement or smooth measurement, refer to the foregoing related descriptions. Details are not described herein again.

905: The terminal device sends K₂ pieces of CSI in the K₁ pieces of CSI to the network device, where K₂ is a positive integer less than or equal to K₁. Correspondingly, the network device receives the K₂ pieces of CSI in the K₁ pieces of CSI from the terminal device.

For example, the terminal device determines five first channel vectors based on five combination matrices, and determines five pieces of CSI based on the five first channel vectors. The terminal device sends the five pieces of CSI to the network device, or sends some of the five pieces of CSI to the network device.

In at least one embodiment, K₂ is equal to K₁. To be specific, the terminal device reports all of the CSI determined by the terminal device.

In at least one embodiment, K₂ is less than K₁, and for the K₂ pieces of CSI, there are the following several cases.

(1) The K₂ pieces of CSI are K₂ pieces of CSI with a maximum utility function in the K₁ pieces of CSI, and K₂ is a positive integer.

Optionally, the network device specifies K₂ for the terminal device. In other words, the network device specifies, for the terminal device, a quantity of pieces of CSI to be reported, or K₂ is protocol pre-specified.

The terminal device maps each piece of CSI to a utility function U according to a specific rule, and select the K₂ pieces of CSI with the maximum utility function to report the CSI to the network device. Specifically, correspondence between the CSI and the utility function U is protocol-predefined, indicated by the network device, or implemented by the terminal device.

Optionally, in an implementation method, the utility function U is spectral efficiency that is obtained based on a given bit error rate, and is related to an RI and a CQI in the CSI. For example, U=RI*f(CQI), where f(CQI) represents single-stream transmission spectral efficiency corresponding to the CQI.

(2) The K₂ pieces of CSI are one or more pieces of CSI with a utility function whose fallback value is less than or equal to a first threshold in the K₁ pieces of CSI, where a fallback value of a utility function of first CSI is a ratio of a utility function of second CSI to the utility function of the first CSI, and the second CSI is CSI with a maximum utility function in the K₁ pieces of CSI.

For example, there are five pieces of CSI with a utility function whose fallback value is less than or equal to the first threshold in the K₁ pieces of CSI, and the terminal device reports the five pieces of CSI to the network device, or report some of the five pieces of CSI to the network device.

Optionally, the utility function of the CSI is related to an RI and a CQI in the CSI.

Optionally, K₂ is determined by the terminal device, and the terminal device reports K₂ to the network device by using separate information, or K₂ is protocol pre-specified.

Optionally, the first threshold is indicated by the network device to the terminal device, or the first threshold is protocol pre-specified.

(3) The K₂ pieces of CSI are CSI with a minimum utility function in CSI with a utility function whose fallback value is less than or equal to a first threshold in the K₁ pieces of CSI, where a fallback value of a utility function of first CSI is a ratio of a utility function of second CSI to the utility function of the first CSI, and the second CSI is CSI with a maximum utility function in the K₁ pieces of CSI.

Optionally, K₂ is equal to 1.

Optionally, the utility function of the CSI is related to an RI and a CQI in the CSI.

Optionally, the first threshold is indicated by the network device to the terminal device, or the first threshold is protocol pre-specified.

(4) The K₂ pieces of CSI are CSI with a maximum utility function in CSI with a utility function whose fallback value is greater than or equal to a second threshold in the K₁ pieces of CSI, where a fallback value of a utility function of first CSI is a ratio of a utility function of second CSI to the utility function of the first CSI, and the second CSI is CSI with a maximum utility function in the K₁ pieces of CSI.

Optionally, K₂ is equal to 1.

Optionally, the utility function of the CSI is related to an RI and a CQI in the CSI.

Optionally, the second threshold is indicated by the network device to the terminal device, or the second threshold is protocol pre-specified. Optionally, in (1) to (4), the terminal device further reports numbers of combination matrices corresponding to the K₂ pieces of CSI, so that the network device knows that the reported CSI is CSI in which channel shutdown pattern.

Based on the implementations in (1) to (4), CSI reporting overheads is reduced.

In at least one embodiment, in response to reporting the K₂ pieces of CSI to the network device, the terminal device differentially reports some feedback amounts in the K₂ pieces of CSI. For example, the CQIs in the CSI is differentially reported. To be specific, a CQI in the 1^{st} piece of CSI (or CSI with a maximum utility function) is first reported, and then a difference between a CQI in the second piece of CSI (or CSI with the second largest utility function) and the CQI of the previous CSI is reported, and so on.

In the method described in FIG. 9. in the HBF architecture, the N antenna ports corresponds to the N analog channel subarrays. One digital channel corresponds to a plurality of analog channel subarrays, and one digital channel corresponds to one antenna port. One combination matrix is used for combining the N analog channel subarrays into a plurality of digital channels. Therefore, one combination matrix is in one-to-one correspondence with one analog channel shutdown pattern. CSI corresponding to a plurality of digital channels in an analog channel shutdown pattern is obtained based on a combination matrix corresponding to the analog channel shutdown pattern and measurement results on all of the analog channel subarrays. According to the method described in FIG. 9, the network device does not send a downlink reference signal in each analog channel shutdown pattern, but sends only one common downlink reference signal, and the terminal device obtains more pieces of CSI in the analog channel shutdown pattern based on limited pilot overheads. In the full aperture architecture, the N antenna ports corresponds to the N digital channels. After some digital channels are closed, corresponding antenna elements is switched to remaining digital channels, so that a quantity of available antenna elements is reserved to maintain a maximum antenna array gain. One combination matrix is used for combining the N digital channels. To be specific, the some digital channels are shut down and the corresponding antenna elements are switched to the remaining digital channels. Therefore, one combination matrix is in one-to-one correspondence with one digital channel shutdown pattern. CSI in a digital channel shutdown pattern is obtained based on a combination matrix corresponding to the digital channel shutdown pattern and measurement results on all of the digital channels. According to the method described in FIG. 9, the network device does not send a downlink reference signal in each digital channel shutdown pattern, but sends only one common downlink reference signal, and the terminal device obtains more pieces of CSI in the digital channel shutdown pattern based on limited pilot overheads.

The following further describes, based on two specific examples, the method described in FIG. 9.

### EXAMPLE 1: DYNAMIC CHANNEL SHUTDOWN AT A GRANULARITY OF AN ANALOG CHANNEL IN AN HBF ARCHITECTURE

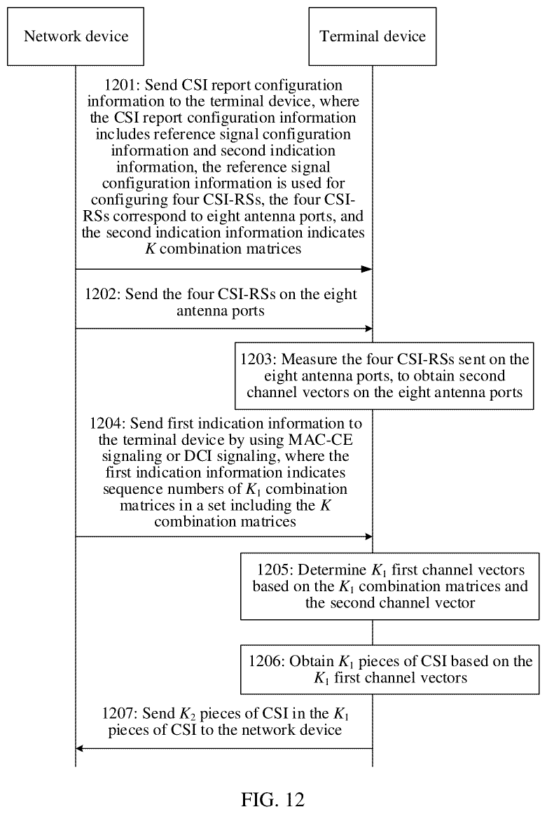

FIG. 12 is a schematic flowchart of another channel state information feedback method according to at least one embodiment. As shown in FIG. 12, the channel state information feedback method includes the following step 1201 to step 1207.

1201: A network device sends CSI report configuration information to a terminal device, where the CSI report configuration information includes reference signal configuration information and second indication information, the reference signal configuration information is used for configuring four CSI-RSs, the four CSI-RSs correspond to eight antenna ports, and the second indication information indicates K combination matrices.

As shown in FIG. 11, a radio frequency unit of the network device includes two digital channels, and analog channels associated with each digital channel are divided into four time-domain non-overlapping subarrays. There are the following 15 types of analog channel shutdown patterns corresponding to a single digital channel: {0001, 0010, 0100, 1000, 0011, 0101, 0110, 1001, 1010, 1100, 0111, 1110, 1111}, where I indicates that a corresponding subarray is open, and 0 indicates that a corresponding subarray is closed.

An antenna port 1 to an antenna port 8 respectively correspond to the analog channel subarray I to the analog channel subarray 8 in FIG. 11. The eight antenna ports are grouped into four antenna port groups. each antenna port group includes two antenna ports, and each antenna port group corresponds to one CSI-RS. Different antenna port groups correspond to different time domain positions. An antenna port group 1 includes the antenna port 1 and the antenna port 5. An antenna port group 2 includes the antenna port 2 and the antenna port 6. An antenna port group 3 includes the antenna port 3 and the antenna port 7. An antenna port group 4 includes the antenna port 4 and the antenna port 8.

Optionally, the reference signal configuration information is alternatively used for configuring only one CSI-RS. which corresponds to eight antenna ports. In this example, an example in which the reference signal configuration information is used for configuring four CSI-RSs is used for description.

For a set of combination matrices. there are the following two cases.
Case 1: Assuming that combination manners of digital ports are the same, there are 15 sets of combination matrices, which respectively correspond to the foregoing analog channel shutdown patterns.
Case 2: in response to different digital ports having different combination manners. there are 15\hat{ }2 sets of combination matrices.

Optionally, K is selected from the sets of combination matrices. For example, for the case 1, the K combination matrices are all of combination matrices, or the K combination matrices are some of the 15 combination matrices, for example, a combination matrix corresponding to {0001, 0010, 0011, 1100, 0111, 1110, 1111}.

1202: The network device sends the four CSI-RSs on the eight antenna ports.

1203: The terminal device measures the four reference signals sent on the eight antenna ports, to obtain second channel vectors on the eight antenna ports.

1204: The network device sends first indication information to the terminal device by using MAC-CE signaling or DCI signaling, where the first indication information indicates sequence numbers of K₁ combination matrices in a set including the K combination matrices.

K₁ is equal to K, or K₁ is less than K.

1205: The terminal device determines K₁ first channel vectors based on the K₁ combination matrices and the second channel vector.

Alternatively, the network device does not send the first indication information, and the terminal device calculates and reports K pieces of CSI based on the K combination matrices and the second channel vector by default, that is, K =K1.

Alternatively, the network device does not send the first indication information, and the terminal device selects the K₁ combination matrices from the K combination matrices to calculate and report CSI. In this example, an example in which the network device sends the first indication information is used for description.

An assumption is that K₁ is 2. The terminal device determines, based on the 1^{st} combination matrix

$${A}_{i} = [ \begin{matrix}1 & 0 & 1 & 0 & 0 & 0 & 0 & 0 \\ 0 & 0 & 0 & 0 & 1 & 0 & 1 & 0\end{matrix} ] ,$$

and the second channel vector H₂, that the first channel vector is H_{1,1}=A₁×H₂. A₁ indicates that the antenna port 1 and the antenna port 3 are combined into an antenna port A, and the antenna port 5 and the antenna port 7 are combined into an antenna port B. The network device sends data through the two combined antenna ports. Therefore, the terminal device measures CSI of the two combined antenna ports. In other words, in the HBF architecture shown in FIG. 11, only the 1^{st} analog channel subarray and the 3^{rd} analog channel subarray are reserved for each digital channel, and other analog channel subarrays are closed.

The terminal device determines, based on the 2^{nd} combination matrix

$${A}_{i} = [ \begin{matrix}1 & 1 & 1 & 0 & 0 & 0 & 0 & 0 \\ 0 & 0 & 0 & 0 & 1 & 1 & 1 & 0\end{matrix} ] ,$$

and the second channel vector H₂, that the first channel vector is H_{1,2}A₂×H₂. A₂ indicates that the 1^{st} antenna port, the 2^{nd} antenna port, and the 3^{rd} antenna port are combined into one antenna port, and the 5^{th} antenna port, the 6^{th} antenna port, and the 7^{th} antenna port are combined into one antenna port. The network device sends data through the two combined antenna ports. Therefore, the terminal device measures CSI of the two combined antenna ports. In other words, in the HBF architecture shown in FIG. 11, only the 1^{st} analog channel subarray; the 2^{nd} analog channel subarray, and the 3^{rd} analog channel subarray are reserved for each digital channel, and the 4^{th} analog channel subarray is closed.

1206: The terminal device obtains K₁ pieces of CSI based on the K₁ first channel vectors.

1207: The terminal device sends K₂ pieces of CSI in the K₁ pieces of CSI to the network device, where K₂ is a positive integer less than or equal to K₁. Correspondingly, the network device receives the K₂ pieces of channel state information CSI in the K₁ pieces of CSI from the terminal device.

Optionally, K₂=K₁.

Optionally, K₂<K₁, and the terminal device calculates a corresponding spectral effect SEᵢ=RIᵢ×Rᵢ×Qᵢ for CSI corresponding to the K₁ combination matrices, where RIᵢ is an RI in CSI corresponding to an i^{th} combination matrix, and Rᵢ and Qᵢ are respectively a code rate and a modulation order that correspond to a CQI in the CSI corresponding to the i^{th} combination matrix. For the K₂ pieces of CSI, there are the following several cases.

(1) The K₂ pieces of CSI are K₂ pieces of CSI with a maximum utility function in the K₁ pieces of CSI. The terminal device further indicates, to the network device, a number of a combination matrix corresponding to reported CSI, so that the network device knows that the reported CSI is CSI in which channel shutdown pattern.

(2) The terminal device determines a maximum utility function SEₘₐₓ, and calculates a fallback value βᵢ=SEₘₐₓ/SEᵢ of a utility function of each piece of CSI. The terminal device finds one or more pieces of CSI that meets βᵢ≤βₜₕ₁, and reports the one or more pieces of CSI to the network device. βₜₕ₁ is a preset threshold, and is configured by the network device in a CSI report. The terminal device further indicates, to the network device, a number of a combination matrix corresponding to the reported CSI, so that the network device knows that the reported CSI is CSI in which channel shutdown pattern.

(3) The terminal device determines a maximum utility function SEₘₐₓ, calculates a fallback value βᵢ=SEₘₐₓ/SEᵢ of a utility function of each piece of CSI, finds CSI with a minimum utility function in CSI that meets βᵢ≤βₜₕ₁. and reports the CSI to the network device. βₜₕ₁ is a preset threshold, and is configured by the network device in a CSI report. The terminal device further indicates, to the network device, a number of a combination matrix corresponding to the reported CSI, so that the network device knows that the reported CSI is CSI in which channel shutdown pattern.

(4) The terminal device determines a maximum utility function SEₘₐₓ calculates a fallback value Bᵢ=SEₘₐₓ/SEᵢ of a utility function of each piece of CSI, finds CSI with a maximum utility function in CSI that meets βᵢ≥βₜₕ₂, and reports the CSI to the network device. βₜₕ₂ is a preset threshold, and is configured by the network device in a CSI report. The terminal device further indicates, to the network device, a number of a combination matrix corresponding to the reported CSI, so that the network device knows that the reported CSI is CSI in which channel shutdown pattern.

### EXAMPLE 2: DYNAMIC CHANNEL SHUTDOWN AT A GRANULARITY OF A DIGITAL CHANNEL IN A FULL APERTURE ARCHITECTURE

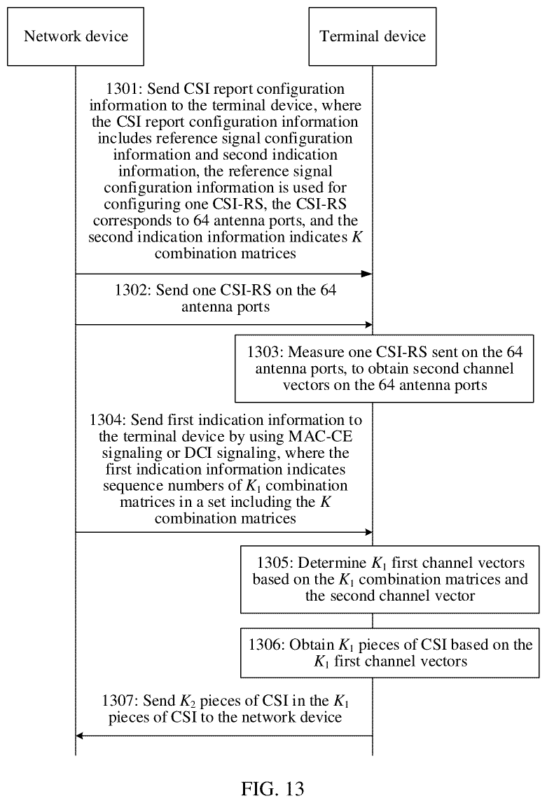

FIG. 13 is a schematic flowchart of still another channel state information feedback method according to at least one embodiment. As shown in FIG. 13, the channel state information feedback method includes the following step 1301 to step 1307.

1301: A network device sends CSI report configuration information to a terminal device, where the CSI report configuration information includes reference signal configuration information and second indication information, the reference signal configuration information is used for configuring one CSI-RS, the CSI-RS corresponds to 64 antenna ports, and the second indication information indicates K combination matrices.

The reference signal configuration information is alternatively used for configuring a plurality of CSI-RSs. In this example, an example in which the reference signal configuration information is used for configuring one CSI-RS is used. Each digital channel is in one-to-one correspondence with an antenna port.

1302: The network device sends one CSI-RS on the 64 antenna ports.

1303: The terminal device measures one reference signal sent on the 64 antenna ports. to obtain second channel vectors on the 64 antenna ports.

1304: The network device sends first indication information to the terminal device by using MAC-CE signaling or DCI signaling, where the first indication information indicates sequence numbers of K₁ combination matrices in a set including the K combination matrices.

1305: The terminal device determines K₁ first channel vectors based on the K₁ combination matrices and the second channel vector.

Assuming that K₁ is 4, the terminal device determines four first channel vectors based on a combination matrix 1 to a combination matrix 4 and the second channel vector. The combination matrix 1 corresponds to the mode 1 of digital channel shutdown and antenna switching shown in FIG. 4. The combination matrix 2 corresponds to the mode 2 of digital channel shutdown and antenna switching shown in FIG. 5. The combination matrix 3 corresponds to the mode 3 of digital channel shutdown and antenna switching shown in FIG. 6. The combination matrix 4 corresponds to the mode 4 of digital channel shutdown and antenna switching shown in FIG. 7. The terminal device determines, based on the four first channel vectors, CSI in the four modes of digital channel shutdown and antenna switching.

Each combination matrix in the K combination matrices is divided into eight submatrices. Each submatrix is responsible for performing channel shutdown and antenna combination on a subarray including four adjacent channels in a V dimension and two adjacent channels in an H dimension. Eight subarrays in charge of the eight submatrices do not overlap, and correspond to 64 digital channels in total.

Each submatrix in the combination matrix 1 is

$${A}_{1 i} = [ \begin{matrix}1 & 0 & 1 & 0 & 0 & 0 & 0 & 0 \\ 0 & 1 & 0 & 1 & 0 & 0 & 0 & 0 \\ 0 & 0 & 0 & 0 & 1 & 0 & 1 & 0 \\ 0 & 0 & 0 & 0 & 0 & 1 & 0 & 1\end{matrix} ] .$$

An antenna port 1 to an antenna port 8 respectively correspond to the digital channel 1 to the digital channel 8 in FIG. 4. The submatrix A₁ᵢ indicates that the antenna port 1 and the antenna port 3 are combined into one antenna port, the antenna port 2 and the antenna port 4 are combined into one antenna port, the antenna port 5 and the antenna port 7 are combined into one antenna port, and the antenna port 6 and the antenna port 8 are combined into one antenna port.

Each submatrix in the combination matrix 2 is

$${A}_{2 i} = [ \begin{matrix}1 & 0 & 1 & 0 & 1 & 0 & 1 & 0 \\ 0 & 1 & 0 & 1 & 0 & 1 & 0 & 1\end{matrix} ] .$$

An antenna port 1 to an antenna port 8 respectively correspond to the digital channel 1 to the digital channel 8 in FIG. 5. The submatrix A₂ᵢ indicates that the antenna port 1, the antenna port 3, the antenna port 5, and the antenna port 7 are combined into one antenna port, and the antenna port 2, the antenna port 4, the antenna port 6, and the antenna port 8 are combined into one antenna port.

Each submatrix in the combination matrix 3 is

$${A}_{3 i} = [ \begin{matrix}1 & 1 & 1 & 1 & 0 & 0 & 0 & 0 \\ 0 & 0 & 0 & 0 & 1 & 1 & 1 & 1\end{matrix} ] .$$

An antenna port 1 to an antenna port 8 respectively correspond to the digital channel 1 to the digital channel 8 in FIG. 6. The submatrix A₃ᵢ indicates that the antenna port 1 to the antenna port 4 are combined into one antenna port, and the antenna port 5 to the antenna port 8 are combined into one antenna port.

Each submatrix in the combination matrix 4 is A₄ᵢ=[1 1 1 1 1 1 1 1]. An antenna port 1 to an antenna port 8 respectively correspond to the digital channel 1 to the digital channel 8 in FIG. 7. The submatrix A₄ᵢ (indicates that the antenna port 1 to the antenna port 8 are combined into one antenna port.

1306: The terminal device obtains K₁ pieces of CSI based on the K₁ first channel vectors.

1307: The terminal device sends K₂ pieces of CSI in the K₁ pieces of CSI to the network device, where K₂ is a positive integer less than or equal to K₁. Correspondingly, the network device receives the K₂ pieces of channel state information CSI in the K₁ pieces of CSI from the terminal device.

For descriptions of K₁ and K₂ in Example 2, refer to the descriptions in Example 1. Details are not described herein again.

To implement the functions in the foregoing embodiments, the network device and the terminal device include corresponding hardware structures and/or software modules for performing the functions. A person skilled in the art should be easily aware that, in combination with the units and the method steps in the examples described in embodiments herein, this at least one embodiment is implemented by using hardware or a combination of the hardware and computer software. Whether a function is performed by hardware or hardware driven by computer software depends on particular application scenarios and design constraints of the technical solutions.

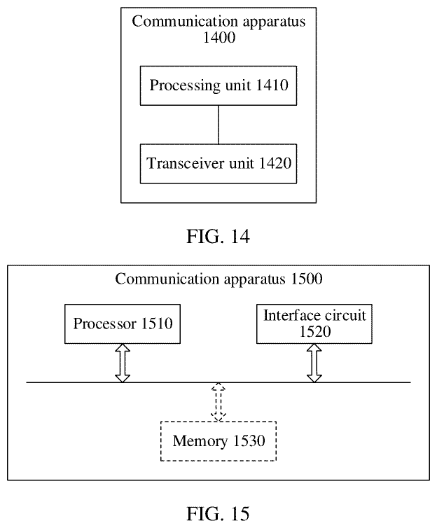

FIG. 14 and FIG. 15 are schematic diagrams of structures of communication apparatuses according to at least one embodiment. The communication apparatuses is configured to implement a function of the terminal device or the network device in the foregoing method embodiments. Therefore, beneficial effects of the foregoing method embodiments is also implemented. In at least one embodiment, the communication apparatus is any one of the terminal devices 120a to 120j shown in FIG. 8, is the network device 110a or 110b shown in FIG. 8, or is a module (for example, a chip) used in the terminal device or the network device.

As shown in FIG. 14, the communication apparatus 1400 includes a processing unit 1410 and a transceiver unit 1420. The communication apparatus 1400 is configured to implement the function of the terminal device or the network device in the method embodiment shown in FIG. 9.

In response to the communication apparatus 1400 being configured to implement the function of the terminal device in the method embodiment shown in FIG. 9, the transceiver unit 1420 is configured to receive reference signal configuration information from the network device, where the reference signal configuration information is used for configuring N₁ reference signals, N₁ is a positive integer, the N₁ reference signals correspond to N antenna ports, and N is an integer greater than 1; the processing unit 1410 is configured to: determine K₁ first channel vectors based on K₁ combination matrices and measurement results of the N₁ reference signals on the N antenna ports, and obtain K₁ pieces of channel state information CSI based on the K₁ first channel vectors; and the transceiver unit 1420 is further configured to send K₂ pieces of CSI in the K₁ pieces of CSI to the network device.

In response to the communication apparatus 1400 being configured to implement the function of the network device in the method embodiment shown in FIG. 9. the transceiver unit 1420 is configured to: send reference signal configuration information to the terminal device, where the reference signal configuration information is used for configuring N₁ reference signals, and the N₁ reference signals correspond to N antenna ports; send the N₁ reference signals on the N antenna ports; and receive K₂ pieces of channel state information CSI in K₁ pieces of CSI from the terminal device; and the processing unit 1410 is configured to process data.

For more detailed descriptions of the processing unit 1410 and the transceiver unit 1420, directly refer to the related descriptions of the method embodiment shown in FIG. 9. Details are not described herein again.

As shown in FIG. 15, the communication apparatus 1500 includes a processor 1510 and an interface circuit 1520. The processor 1510 and the interface circuit 1520 are coupled to each other. The interface circuit 1520 is a transceiver or an input/output interface. Optionally, the communication apparatus 1500 further includes a memory 1530, configured to: store instructions executed by the processor 1510, or store input data used by the processor 1510 to run the instructions, or store data generated after the processor 1510 runs the instructions.

In response to the communication apparatus 1500 being configured to implement the method shown in FIG. 9, the processor 1510 is configured to implement the function of the processing unit 1410, and the interface circuit 1520 is configured to implement the function of the transceiver unit 1420.

In response to the communication apparatus being the chip used in the terminal device, the chip in the terminal device implements the function of the terminal device in the foregoing method embodiments. The chip in the terminal device receives information from another module (for example, a radio frequency module or an antenna) in the terminal device, where the information is sent by the network device to the terminal device. Alternatively, the chip in the terminal device sends information to another module (for example, a radio frequency module or an antenna) in the terminal device, where the information is sent by the terminal device to the network device.

In response to the communication apparatus being the module used in the network device, the module in the network device implements the function of the network device in the foregoing method embodiments. The module in the network device receives information from another module (for example, a radio frequency module or an antenna) in the network device, where the information is sent by the terminal device to the network device. Alternatively, the module in the network device sends information to another module (for example, a radio frequency module or an antenna) in the network device, where the information is sent by the network device to the terminal device. The module in the network device herein is a baseband chip of the network device, or is a DU or another module. The DU herein is a DU in an open radio access network (O-RAN) architecture.

The processor in at least one embodiment is a central processing unit (CPU), or is another general-purpose processor, a digital signal processor (DSP), an application-specific integrated circuit (ASIC). a field programmable gate array (FPGA) or another programmable logic device, a transistor logic device, a hardware component, or any combination thereof. The general-purpose processor is a microprocessor or any regular processor.

The method steps in at least one embodiment is implemented in a hardware manner, or is implemented in a manner of executing software instructions by the processor. The software instructions includes a corresponding software module. The software module is stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to a processor, so that the processor reads information from the storage medium and writes information into the storage medium. The storage medium is a component of the processor. The processor and the storage medium are located in the ASIC. In addition, the ASIC is located in the network device or the terminal device. The processor and the storage medium alternatively exist in the network device or the terminal device as discrete components.

All or some of the foregoing embodiments is implemented by software, hardware, firmware, or any combination thereof. in response to the software being used to implement embodiments, all or some of embodiments is implemented in a form of a computer program product. The computer program product includes one or more computer programs or instructions. in response to the computer programs or instructions being loaded and executed on a computer, all or some of the procedures or functions in at least one embodiment are executed. The computer is a general-purpose computer, a dedicated computer, a computer network, a network device, user equipment, or another programmable apparatus. The computer programs or instructions is stored in a computer-readable storage medium, or is transmitted from a computer-readable storage medium to another computer-readable storage medium. For example, the computer programs or instructions is transmitted from a website, computer, server, or data center to another website, computer, server, or data center in a wired manner or in a wireless manner. The computer-readable storage medium is any usable medium that is accessed by a computer, or a data storage device, such as a server or a data center, integrating one or more usable media. The usable medium is a magnetic medium, for example, a floppy disk, a hard disk, or a magnetic tape; or is an optical medium, for example, a digital video disc; or is a semiconductor medium, for example, a solid-state drive. The computer-readable storage medium is a volatile or nonvolatile storage medium, or includes two types of storage media: the volatile storage medium and the non-volatile storage medium.

In at least one embodiment, unless otherwise stated or there is a logic conflict, terms and/or descriptions between different embodiments are consistent and is mutually referenced, and technical features in different embodiments is combined into a new embodiment based on an internal logical relationship thereof.

1. A channel state information feedback method, performed by a communication apparatus, wherein the method comprises:
receiving reference signal configuration information from a network device, wherein the reference signal configuration information is usable for configuring N₁ reference signals, N₁ is a positive integer, the N₁ reference signals correspond to N antenna ports, and N is an integer greater than 1;
determining K₁ first channel vectors based on K₁ combination matrices and measurement results of the N₁ reference signals on the N antenna ports, wherein an i^{th} combination matrix in the K₁ combination matrices is usable for combining the N antenna ports into Mᵢ antenna ports, an i^{th} first channel vector in the K₁ first channel vectors is a channel vector on the Mᵢ antenna ports, Mᵢ is less than or equal to N, Mᵢ is a positive integer, K₁ is a positive integer, and 1≤i≤K₁;
obtaining K₁ pieces of channel state information (CSI) based on the K₁ first channel vectors; and
sending K₂ pieces of CSI in the K₁ pieces of CSI to the network device, wherein K₂ is a positive integer less than or equal to K₁.

2. The method according to claim 1, wherein the combining the N antenna ports into the Mᵢ antenna ports using the i^{th} combination matrix includes combining second channel vectors into the first channel vector on the Mᵢ antenna ports using the i^{th} combination matrix, and the second channel vectors are channel vectors that are on the N antenna ports and that are obtained based on the measurement results on the N antenna ports.

3. The method according to claim 1, wherein the determining the K₁ first channel vectors based on the K₁ combination matrices and the measurement results of the N₁ reference signals on the N antenna ports includes grouping the N antenna ports into N₂ antenna port groups, N₂ is an integer greater than 1, different antenna port groups in the N₂ antenna port groups correspond to different time domain positions, each antenna port group in the N₂ antenna port groups includes N₃ antenna ports, N₃ is a positive integer, and N=N₂×N₃.

4. The method according to claim 3, wherein the determining the measurement results of the N₁ reference signals on the N antenna ports and the grouping the grouping the N antenna ports into N₂ antenna port groups includes determining the measurement results of the N₁ reference signals on the N antenna ports and grouping the grouping the N antenna ports into N₂ antenna port groups where N₂=N₁, or N₂/N₁ is an integer greater than 1.

5. The method according to claim 2, wherein the combining the second channel vectors into the first channel vector on the Mᵢ antenna ports using the i^{th} combination matrix includes combining the second channel vectors into the first channel vector on the M_i antenna ports using the i^{th} combination matrix with the second channel vector being H₂, the i^{th} first channel vector being H_{1,i}, H_{1,i}=Aᵢ×H₂, wherein Aᵢ is the i^{th} combination matrix, and Aᵢ=[a_{m,n}]_{1≤m≤M}_{ᵢ}_{, 1≤n≤N}, and wherein a_{m,n} is an element in an m^{th} row and an n^{th} column of the combination matrix Aᵢ.

6. The method according to claim 5, wherein the combining the second channel vectors into the first channel vector on the M_i antenna ports using the i^{th} combination matrix with the second channel vector being H₂, the i^{th} first channel vector being H_{1,i}, H_{1,i}=Aᵢ×H₂, wherein Aᵢ is the i^{th} combination matrix, and Aᵢ=[a_{m,n}]_{1≤m≤M}_{ᵢ}_{, 1≤n≤N}, and wherein a_{m,n} is 1 or 0; or a_{m,n} is 0 or aₘ, and aₘ is protocol-predefined or aₘ is configured by the network device.

7. The method according to claim 5, wherein the combining the second channel vectors into the first channel vector on the M_i antenna ports using the i^{th} combination matrix with the second channel vector being H₂, the i^{th} first channel vector being H_{1,i}, H_{1,i}=Aᵢ×H₂, wherein Aᵢ is the i^{th} combination matrix, and Aᵢ=[a_{m,n}]_{1≤m≤M}_{ᵢ}_{, 1≤n≤N}, and wherein a_{m,n1} and a_{m,n2} exist in Aᵢ, a_{m,n1}>0, a_{m,n2}>0, and n1 is not equal to n2.

8. An apparatus, comprising:
one or more memories storing programming instructions; and
at least one processor coupled to the one or more memories, wherein the at least one processor is configured to execute the programming instructions to perform operations of:
receiving reference signal configuration information from a network device, wherein the reference signal configuration information is usable for configuring N₁ reference signals, N₁ is a positive integer, the N₁ reference signals correspond to N antenna ports, and N is an integer greater than 1;
determining K₁ first channel vectors based on K₁ combination matrices and measurement results of the N₁ reference signals on the N antenna ports, wherein an i^{th} combination matrix in the K₁ combination matrices is usable for combining the N antenna ports into Mᵢ antenna ports, an i^{th} first channel vector in the K₁ first channel vectors is a channel vector on the Mᵢ antenna ports, Mᵢ is less than or equal to N, Mᵢ is a positive integer, K₁ is a positive integer, and 1≤i≤K₁;
obtaining K₁ pieces of channel state information (CSI) based on the K₁ first channel vectors; and
sending K₂ pieces of CSI in the K₁ pieces of CSI to the network device, wherein K₂ is a positive integer less than or equal to K₁.

9. The apparatus according to claim 8, wherein that the i^{th} combination matrix is usable for combining the N antenna ports into the Mᵢ antenna ports is specifically as follows: the i^{th} combination matrix is usable for combining second channel vectors into the first channel vector on the Mᵢ antenna ports, and the second channel vectors are channel vectors that are on the N antenna ports and that are obtained based on the measurement results on the N antenna ports.

10. The apparatus according to claim 8, wherein the N antenna ports are grouped into N₂ antenna port groups, N₂ is an integer greater than 1, different antenna port groups in the N₂ antenna port groups correspond to different time domain positions, each antenna port group in the N₂ antenna port groups includes N₃ antenna ports, N₃ is a positive integer, and N=N₂×N₃.

11. The apparatus according to claim 10, wherein N₂=N₁, or N₂/N₁ is an integer greater than 1.

12. The apparatus according to claim 9, wherein the second channel vector is H₂, the i^{th} first channel vector is H_{1,i}, H_{1,i}=Aᵢ×H₂, Aᵢ is the i^{th} combination matrix, and Aᵢ=[a_{m,n}]_{1≤m≤M}_{ᵢ}_{, 1≤n≤N}, wherein a_{m,n} is an element in an m^{th} row and an n^{th} column of the combination matrix Aᵢ.

13. The apparatus according to claim 12, wherein a_{m,n} is 1 or 0; or a_{m,n} is 0 or aₘ, and aₘ is protocol-predefined or aₘ is configured by the network device.

14. The apparatus according to claim 12, wherein a_{m,n1} and a_{m,n2} exist in Aᵢ, a_{m,n1}>0, a_{m,n2}>0, and n1 is not equal to n2.

15. An apparatus, comprising:
one or more memories storing programming instructions; and
at least one processor coupled to the one or more memories, wherein the at least one processor is configured to execute the programming instructions to perform operations of:
sending reference signal configuration information to a terminal device, wherein the reference signal configuration information is usable for configuring N₁ reference signals, N₁ is a positive integer, the N₁ reference signals correspond to N antenna ports, and N is an integer greater than 1;
sending the N₁ reference signals on the N antenna ports; and
receiving K₂ pieces of channel state information CSI in K₁ pieces of CSI from the terminal device, wherein K₂ is a positive integer less than or equal to K₁, the K₁ pieces of CSI are obtained based on K₁ first channel vectors, the K₁ first channel vectors are obtained based on K₁ combination matrices and measurement results on the N antenna ports, an i^{th} combination matrix in the K₁ combination matrices is usable for combining the N antenna ports into Mᵢ antenna ports, an i^{th} first channel vector in the K₁ first channel vectors is a channel vector on the Mᵢ antenna ports, Mᵢ is less than or equal to N, Mᵢ is a positive integer, K₁ is a positive integer, and 1≤i≤K₁.

16. The apparatus according to claim 15, wherein that the ith combination matrix is usable for combining the N antenna ports into the Mᵢ antenna ports is specifically as follows: the i^{th} combination matrix is usable for combining second channel vectors into the first channel vector on the Mᵢ antenna ports, and the second channel vectors are channel vectors that are on the N antenna ports and that are obtained based on the measurement results on the N antenna ports.

17. The apparatus according to claim 15, wherein the N antenna ports are grouped into N₂ antenna port groups, N₂ is an integer greater than 1, different antenna port groups in the N₂ antenna port groups correspond to different time domain positions, each antenna port group in the N₂ antenna port groups comprises includes N₃ antenna ports, N₃ is a positive integer, and N=N₂×N₃.

18. The apparatus according to claim 17, wherein N₂=N₁, or N₂/N₁ is an integer greater than 1.

19. The apparatus according to claim 15, wherein the second channel vector is H₂, the i^{th} first channel vector is H_{1,i}, H_{1,i}=Aᵢ×H₂, Aᵢ is the i^{th} combination matrix, and Aᵢ=[a_{m,n}]_{1≤m≤M}_{ᵢ}_{, 1≤n≤N}, wherein a_{m,n} is an element in an m^{th} row and an n^{th} column of the combination matrix Aᵢ.

20. The apparatus according to claim 19, wherein a_{m,n} is 1 or 0; or a_{m,n} is 0 or aₘ, and aₘ is protocol-predefined or aₘ is determined by the communication apparatus.
